(19) United States
(12) Patent Application Publication
(10) Pub. No.: US 2008/0148352 A1
(43) Pub. Date: Jun. 19, 2008

(54) Authenticating Device

(76) Inventors: Makoto Matsumoto, Hiroshima (JP); Mutsuo Saito, Hiroshima (JP)

Correspondence Address: HARNESS, DICKEY & PIERCE, P.L.C., P.O. BOX 8910, RESTON, VA, 20195, US

(21) Appl. No.: 11/885,078

(22) PCT Filed: Feb. 16, 2006
(86) PCT No.: PCT/JP2006/002703

§ 371 Date: Aug. 24, 2007

(30) Foreign Application Priority Data
Feb. 28, 2005 (JP) 2005-055073

(51) Int. Cl. G06F 21/00

(52) U.S. Cl. 726/2

(57) ABSTRACT

An authenticating device authenticates a user by using an authenticating card having holes formed at positions unique to the user and has the following sections (A) to (C). (A) A random image creating section for creating a condition-meeting random image meeting the condition that at least one set of color unit images of the same color are present at positions corresponding to two holes when the authenticating card is placed over the images of colors randomly arranged. (B) A matching section for judging whether or not the color represented by answer information of the user is one of the colors of at least the one set of color unit images doubly viewed through the two holes of the authenticating card when the authenticating card is placed over eth condition-meeting random image (condition (b)). (C) An authentication judging section for judging that the user is successfully authenticated when the matching section repeats judgment repetition times RN meeting condition (c) mentioned below and judges that the color represented by the answer information meets condition (b) at all the repeated judgments. Condition (c): RN meets the condition that (G₁/CN× . . . ×(G_{RN}/CN) is a predetermined value or less where CN is the number of different colors, and Gi is the number of sets of color unit images of the same color present at two holes when the authenticating card is placed over the condition-meeting random image at the i-th judgment.

### TECHNICAL FIELD

The present invention relates to an authenticating device for authenticating a user.

### BACKGROUND ART

Recent improvement in communication networks has made it possible to access to various host computers via communication networks. For example, a customer of a bank can access to a host computer that is under management of the bank, and carry out various transactions such as making a balance inquiry of his bank account, money transfer, etc. In such a transaction, the host computer should perform authentication to find out whether a user requesting an access thereto is a true registered user.

Most widely used authentication system is a password authentication system. The password authentication system is vulnerable to password leakage in the communication path, stealing password by using a fake server that fakes the true host server, stealing password by using a key input recording program installed on a terminal computer, or the like attempt of stealing the password. Moreover, the password tends to be such a kind that is easy to remember, such as a birthday. Such a password is easy to estimate by the other person.

The followings are examples of arts for improving the security of the authentication system.

For example, Japanese Patent Application Publications, Tokukaihei No. 10-307799 (published on Nov. 17, 1998; hereinafter, referred to as Patent Citation 1), Tokukai No. 2000-172644 (published on Jun. 23, 2000) (hereinafter, referred to as Patent Citation 2), Tokukai No. 2003-256373 (published on Sep. 12, 2003; hereinafter, referred to as Patent Citation 3) disclose systems which use a table on which a number or picture is randomly arranged 2-dimentionally. A user side receives the table from a server, and memorizes a predetermined positional pattern on the table as a secret positional pattern. The user inputs numbers or pictures corresponding to the positions of the positional pattern, or inputs a result of a calculation using the numbers corresponding to the positions. The numbers, pictures, or the result of the calculation is send to the server. In this configuration, the password inputted by the user is, so called, one-time password, which is varied according to the table transmitted from the server.

Moreover, Japanese Patent Application Publication, Tokukaihei No. 11-149454 (published on Jun. 2, 1999; hereinafter, referred to as Patent Citation 4) discloses a system in which a client has a coordinate detector for receiving an input of predetermined coordinates, and authentication is performed by matching the inputted coordinates with registered coordinates.

System that are regarded as the safest today are two-way authentication systems which utilize a one-way function via a portable electronic computing device (such as an IC card) having a calculation ability (Japanese Patent Application Publication, Tokukai No. 2001-69138 (published on Mar. 16, 2001; hereinafter, referred to as Patent Citation 5). A bank side transmits random numbers to a terminal of a customer. The customer inputs the received random numbers to the portable electronic computing device. A result of calculation performed by the portable electronic computing device is inputted in a network terminal. Some of these authentication systems are further improved such that the authentication is performed by using, in combination, a fingerprint reading device and a portable electronic computing device for fear of possible theft of the portable electronic computing device.

In the arts disclosed in Patent Citations 1 to 3, however, the eavesdropper would easily estimate the secret pattern the user memorizes, if the table and the one-time password are eavesdropped on the communication path again and again. For example, assume that three combinations of the information of the random two-dimensional tables and one-time passwords are leaked. Let that a first letter of the one-time password is “3”, a second letter “5”, and a third letter “7”. This readily explains that the position on the tables which gives the first letter of the one-time password is located at “3” on the first table, “5” on the second table, and “7” on the third table. The expected value of the number of such positions is a multiple of the number of the positions on the table with ( 1/10)×( 1/10)×( 1/10). Thus, if the table merely had 1000 positions or less, the position could be estimated at highly possibility. Not only the first letter but also to any letter in the string can be estimated by this method. With this, it is possible to estimate the secret positional pattern that is kept secret by the user.

Eavesdropping would not be necessary to estimate the secret positional pattern if the table transmitted from the server and the one-time password are remained in a memory of the user-side terminal. In this case, the secret positional pattern can be estimated by reading the memory. This is highly possible especially if a terminal device placed in public is used. Even for a terminal device of private use, the terminal device would be infected with a virus that transmits to another terminal the table displayed thereon and the one-time password inputted therein. Moreover, the information that can be obtained by eavesdropping the plurality of the tables and the one-time passwords can be obtained by using a fake server faking the true server.

In the art described in Patent Citation 4, the coordinates can be stolen easily from the user by using a fake server that fakes a true server.

Moreover, two-way authentication system using a portable electronic computing device has a costwise problem because it needs special devices such as the IC cards, IC card reading device, and the fingerprint reading device.

The present invention is accomplished in view of the aforementioned problems, and an object of the present invention is to realize an authenticating device constituting an authenticating system having a high security and a low cost.

### DISCLOSURE OF INVENTION

In order to attain an object mentioned above, an authenticating device of the present invention recited in claim 1 is an authenticating device for authenticating a user by using a display device, an input device, and an authentication card in which holes or transparent sections are arranged at plural positions in a way specific to the user, the device including (A) to (C): (A) random image display means for creating a condition meeting random image and causing the display device to display the condition meeting random image, the condition meeting random image including colored unit images being colored with various colors and randomly arranged therein in such a way that meets a condition (a),

where the condition (a) is such that at least one pair of the colored unit images of the same color appears through two holes or two transparent sections when the authentication card is superimposed on the condition meeting random image,

(B) judging means for obtaining, from the input device, answer information indicating one of the colors, and for judging whether the color indicated by the obtained answer information meets a condition (b),

where the condition (b) is such that the color indicated by the obtained answer information is one of the color(s) of the at least one pair of the colored unit images appearing through the two holes or two transparent sections when the authentication card is superimposed on the condition meeting random image,

(C) authentication control means for performing such authentication that the authentication is successful if the judging means repeats the judging process RN times and judges that the answer information meets the condition (b) in all the RN-time judging processes, where RN meets a condition (c) or (d),

where the condition (c) is such that (G₁/CN)×(G₂/CN)× . . . ×(G_{RN}/CN)≦a predetermined value, where CN is a number of the plural colors, and Gi is a number of pairs of colored unit images of the same color appearing through two of the holes or the transparent sections when the authentication card is superimposed on the condition meeting random image at an i-th judging process, and

where the condition (d) is such that (G/CN)RN≦a predetermined value, where CN is the number of the plural colors, and G is an expected value of the number of pairs of the colored unit images of the same color appearing through the two of the holes or the transparent sections when the authentication card is superimposed on the condition meeting random image.

With the structures (A) to (C) of claim 1, the random image display means causes the display of the condition meeting random image in which at least one pair of the colored unit images of the same color appears through two holes or two transparent sections of the authentication card. The authentication card has the holes or transparent sections at positions specific to the user (hereinafter, a pattern of the positions is referred to as a secret positional pattern). With this, the user superimposes his authentication card on the condition meeting random image displayed on the display device, and inputs, as answer information, the color of the colored unit images appearing through two holes or two transparent sections. Then, the judging means judges whether the color indicated by the answer information meets the condition (b) or not. If the true user inputs a correct answer, the judging means judges that the color indicated by the answer information meets the condition (b).

Here, a possibility that a color randomly selected and inputted as the answer information by a false user not owning the authentication card is judged as meeting the condition (b) by the judging means is G/CN, where G is the number of the combinations of the colored unit images of the same colors appearing through two holes or two transparent sections and CN is a number of the colors.

To avoid the error to mistakenly authorize the false user not having the authorization card, the authorization control means judges as successful authorization only if the judging means judges repeats the judging processes RN times, which meet the condition (c) or (d), and judges that the color indicated by the answer information meets the condition (b) in all the judging processes. By this, the possibility that the random input of answer information is successfully authorized can be reduced to a predetermined value or less (e.g., 1/100000 or less) described in the condition (c) or (d). Thus, an access by the false user not having the authorization card can be rejected with high possibility.

Moreover, the answer information indicates the color of the colored unit image appearing through two of the holes or transparent sections formed on the authorization card. That is, the answer information is a color selected from the combinations of the color unit images appearing through all the holes or transparent sections of the authorization card. Thus, even if combinations of the condition meeting random image and answer information are eavesdropped plural times, a very complicate algorithm is necessary to estimate the secret positional pattern of the condition meeting random image, so as to find out the combinations from the secret positional pattern.

When the problem to estimate the positions of the holes on the authorization card from the combinations of the displayed condition meeting random image and the answer information is generalized and it is assumed that there is no limit in the number of the kinds (colors) of the colored unit images and the number of holes, it is possible to prove that this problem belongs to the NP-complete problem, which is regarded as the most difficult problem among the problems that requires the use of a computer to solve. Thus, it is impossibly difficult to estimate the secret positional pattern of the holes or transparent sections, which is set specifically to the user, thereby attaining a high security.

Moreover, the random image created by the fake authorizing device faking the authorizing device will not meet the condition (a), because the fake authorizing device does not know the positions of the holes or transparent sections specific to the user. This allows the user to find out that the fake authorizing device is a fake one because the combination of the colored unit images appearing through two holes or two transparent sections when the authorizing card is superimposed on the random image does not meet the condition (a). This prevents the fake authorizing device from stealing the answer information.

Moreover, the user owns the authorization card and thus does not need to memorize the positions of the holes or the transparent sections. This allows an increase in the number of the holes or transparent sections, whereby it becomes difficult to estimate the positions of all the holes or transparent sections even if the communication is eavesdropped.

Moreover, the authorization card can be produced at a much lower cost than the fingerprint reading device or the portable electronic computing device. The low cost of the authorization card makes it possible to provide the user with authorization cards having different secret positional patterns every predetermined number of times the authorization card is used (or every predetermined period of service the authorization card is used). In this way, the secret positional pattern of the authorization card provided to the user specifically is changed every predetermined number of times the authorization card is used. This makes it difficult for the eavesdropper to estimate the secret positional pattern even if the eavesdropper eavesdrops the communication.

The number of repeating may be selected on the authorizing device side. For example, if an amount of payment is predetermined, the number of repeating may be adjusted to appropriately reduce the possibility of the error of accidental authorization of random input according to how much the amount of payment is. That is, the predetermined values in the conditions (c) and (d) can be changed arbitrarily.

Moreover, by the authorizing device side, each authorization card may be independently set as to a sum of the money that can be used by the authorizing card. The period of service of the authorization card may be set according to a sum of the payment made via the authorization card, or according to how many times the authorization card has been used, instead of when the period of service will be expired. This can set an upper limit on a damage caused in the event that the authorization card is stolen. Moreover, it is possible to prevent the leak of the secret positional pattern due to repeated usage.

The random image display means causes the display device to display the condition meeting random image. If the display device has a display section such as a display or the like, the display device displays the condition meeting random image thereon. If the display device has a function of printing out an image on a medium such as paper, the display device displays the condition meeting random image on the medium by the printing process.

As described above, it is possible to realize an authorizing system having a high security and a low cost.

Furthermore, due to the use of the colored unit images, the user is required to recognize only the color, which is easier to recognize compared with letters or the like. Moreover, the colored unit images are only required to show the color. Thus, the number of dots necessary for the colored unit images can be smaller. Consequently, the magnifying/shrinking process to adjust the condition meeting random image to a certain shape can be easily performed.

Moreover, the user dose not need to recognize a shape in this case, unlike the case where the letters or the like are used. Thus, the colored unit image can be small in size. This allows increasing the number of the holes or transparent sections of the authorization card. As a result, it becomes more difficult to estimate the positions of the holes or transparent section specific to the user.

An authenticating device of the present invention recited in claim 2 is arranged such that the condition meeting random image caused to be displayed by the random image display means meets a condition (e) in addition to the condition (a),

where the condition (e) is such that colored unit images of a color do not appear through three or more holes or transparent sections when the authentication card is superimposed on the condition meeting random image.

The possibility that an image in which the colored unit images are randomly arranged meets the condition (e) can be smaller that the possibility that the image meets only the condition (a). For example, assume the number of the colors is 16, and the number of the holes is 11, the possibility that a certain color appearing through three or more holes is approximately 0.402. Thus, the addition of the condition (e) increases the possibility that the fake authorizing device faking the authorizing device displays a random image that does not meet the condition (e). Consequently, the user can recognize the fake authorizing device as a fake one with high possibility.

An authenticating device of the present invention recited in claim 3 or 14 is the authenticating device as set forth in claim 1 or 2, including a positional information storage section for storing positional information in association with the user, the positional information indicating where the holes or transparent sections are located on the authentication card, the random image display means performing the creation of the condition meeting random image, based on positional information associated with the user to be authenticated, and the judging means performing the judging process, based on positional information associated with the user who requests the authentication. By this, it is possible to perform the authentication process of each user with no problem in response to authentication requests from plural users.

Moreover, an authenticating device recited in claim 4 or 15 is the authenticating device as set forth in claim 1 or 2, wherein: the authentication card including sub cards in which holes or transparent sections are arranged at plural positions in a way specific to the user, the sub cards being changeable in their relative positions by sliding; and holes or transparent sections common to all the sub cards stacked and positioned respectively at certain relative positions are used as the holes or the transparent sections of the authentication card.

In the arrangement of claim 4 or 15, the user uses the holes or transparent section common to all the sub cards stacked and respectively positioned at the certain relative positions. If the sub cards are held in a certain holder, which is sealed by a bonding method such as fusing, an unauthorized person should break the holder and remove the sub cards therefrom in order to copy the sub cards. Thus, it is possible to know that the sub cards have been copied for falseness.

Moreover, in addition to the arrangement of claim 4 or 15, an authenticating device recited in claim 5 or 16 further increases (E) a sub positional information storage section for storing sub positional information in association with the user, the sub positional information indicating where the holes or transparent sections are located on the sub cards; and (F) common position extracting means for reading out, from the sub positional information storage section, sub positional information associated with a user to be authenticated, and for extracting common positions based on the read-out sub positional information, the common positions being positions where the holes or transparent sections common to all the sub cards are located when the sub cards are stacked and relatively positioned at the certain relative positions, the random image display means performing the creation of the condition meeting random image, based on the common positions extracted by the common position extracting means, and the judging means performing the judging process based on the common positions extracted by the common position extracting means.

With the structures (E) and (F) of claim 5 or 16, the common position extracting means can easily extract the positions of the holes or transparent sections common to all the sub cards positioned at various relative positions.

Furthermore, in addition to the arrangement of claim 5 or 16, an authenticating device of the present invention recited in claim 6 or 17 further includes: (G) relative position creating means for creating the relative positions of the sub cards per authentication; and (H) relative position displaying means for causing the display device to display the relative positions created by the relative position creating means, the common position extracting means performing the extraction of the common positions based on, as the certain relative positions, the relative positions created by the relative position creating means.

In the structures (G) and (H), the relative position creating means creates the relative positions of the stacked sub cards. Then, the relative position display means causes the display device to display the relative positions thereon. By this, it is possible to change the relative positions of the stacked sub cards per authentication. As a result, the positions of the holes or transparent sections common to all the sub cards are different every time. Accordingly, even if the condition meeting random image and the answer information are eavesdropped, it is very difficult for the eavesdropper to find out where the holes or the transparent sections of all the sub cards owned by the user are located. This improves the security.

Moreover, in addition to the arrangement of claim 5 or 16, an authenticating device of the present invention recited in claim 7 or 18 includes: (I) a relative position storage section for storing the certain relative positions in association with user identification information, the common position extracting means reading out, from the relative position storage section, the certain relative positions associated with the user to be authenticated, and performing the extraction of the common positions based on the read-out certain relative positions.

With the structure (I), the relative positions of the stacked sub cards can be utilized as a secret password. That is, the user may memorize the relative positions and stack the sub cards, positioning the sub cards at the memorized relative positions in performing the authentication. Even if all the sub cards are stolen, how to stack the sub cards is unknown. Thus, the risk of false use of the sub cards is low.

In addition to the arrangement of claim 5 or 16, an authenticating device recited in claim 8 or 19 further includes: (J) relative position creating means for creating part of the relative positions of the sub cards per authentication; (K) relative position display means for causing the display device to display the relative positions created by the relative position creating means; and (L) a relative position storage section for storing the rest of the relative positions of the sub cards, the common position extracting means determining the certain relative positions, based on the relative positions being created by the relative position creating means, and the relative positions being read out from the relative position storage section and associated with the user.

With the structures (J) to (L), the positions of the holes or transparent sections common to all the sub cards are different every authentication process. Thus, even if the answer information and the condition meeting random image are eavesdropped, it is very difficult to find out the positions of the holes or transparent sections of all the sub cards owned by the user. Furthermore, even if all the sub cards are stolen, how to stack the sub cards is unknown. Thus, the risk of false use of the sub cards is low.

Moreover, in addition to the arrangement of claim 1, an authenticating device of the present invention recited in claim 9 is arranged such that: if the authentication card has the holes, at least one of the holes is provided with a colored transparent section, or if the authentication card has transparent sections, at least one of the transparent sections is a colored transparent section, the authenticating device comprising a color information storage section for storing color position information and color information, the color position information indicating where the colored transparent section is located and the color information indicating the color of the colored transparent section, the random image creating section performing the creation of the condition meeting random image, based on the color information, the condition meeting random image meeting the condition (a) in terms of a combination of (i) a combination color of the color of a colored unit images appearing through the colored transparent section and the color of the colored transparent section, and (ii) the colors of the colored unit images appearing through the holes or transparent sections not provided with the colored transparent section.

With this arrangement of claim 9, even if the condition meeting random image and the answer information are eavesdropped, it is very difficult to find out from the eavesdropped information the colors and the positions of the transparent sections in the authentication card specific to the user. This results in better security.

Moreover, an authenticating device of the present invention recited is claim 10 is the authenticating device as set forth in claim 1, wherein: the judging means uses a condition (f) instead of the condition (b), where the condition (f) is such that the color is a color not appearing through plural holes or transparent sections of the authentication card when the authentication card is superimposed on the condition meeting random image.

With the condition (f), the user is only required to input a color appearing only one hole or transparent section. Thus, it is easy for the user to find the color to be the answer information.

For better security, a greater number of the holes is preferable. However, if the number of the holes was increased with the number of the color unchanged, the number of colors appearing through plural holes would be increased. Consequently, the authentication of the systems described so far would require a more number of repeating. In view of this, if the number of the holes was increased and it was arranged that a color appearing through only one hole is inputted, the security can be improved without increasing the number of repeating. For example, assume the number of the color is 7 and the number of holes is 10. In this case, at least three colors will appear through plural holes. Thus, with the systems described so far, a random input would answer correctly with a possibility of 3/7. If the number of the holes is 13, 6 colors appears through plural holes. Thus, a random input would answer correctly with a possibility of 6/7. With the system recited in this claim, a random input would answer correctly with a possibility of 1/7, where the number of the holes is 13 and 6 colors are appearing through plural holes. This reduces the number of repeating RN.

An authenticating device of the present invention recited in claim 11 or 20 is the authenticating device as set forth in claim 1 or 12, wherein: the random image display means includes, in the condition meeting random image, colored unit images of a color identical with a background color of the authentication card at a certain proportion.

With the arrangement of claim 1 or 20, some colored unit images of the background color of the authentication card appear through the holes or transparent sections. This seems to the user that the number of the holes or transparent sections is reduced. It is easier for the user to find which color should be answer from among the colors of the colored unit images appearing through the rest of the holes or transparent sections.

Moreover, by arranging to create such a condition meeting random image that the background color of the authentication card appear through a predetermined number of the holes or transparent sections, the possibility that the fake authentication device creates the condition meeting random image by accident is lowered. Thus, the user can find out that the fake authenticating device is a fake one.

An authenticating device of the present invention recited in claim 12 is the authenticating device as set forth in claim 1, wherein: instead of the colored unit images, the authenticating device uses at least one of: first unit images which are at least one of characters, pictures, symbols, or numbers; second unit images which are changed over time and distinctive by an amount of the change over time; and third unit images which are combinations of at least two of the elements consisting of colored image, characters, pictures, symbols, numbers, and images which are changed over time and distinctive by an amount of the change over time.

Here, the unit images that change over time include, for example, a blinking image that blinks periodically and an image in which an image and another image alternatively replace each other periodically. Moreover, the amount of change over time is, for example, blinking intervals or blinking timing in case of a blinking image in which a unit image blinks periodically.

In case where the first unit images are used, a degree of freedom in the unit image is increased. Moreover, in case where the second unit images are used, the user can distinguish the second unit images from each other referring to the amount of change over time. That is, by using the amount of change over time as a parameter, it is possible to increase the kinds of the second unit image. Further, in case where the third unit images are used, the number of possible kinds of the unit image is a multiple of the number of kinds of each element. This gives a greater degree of freedom in the kinds to select.

Moreover, an authenticating device of the present invention recited in claim 13 is the authenticating device as set forth in claim 1, wherein: the authenticating device uses third unit images which are combinations of at least two of the elements consisting of colored images, characters, pictures, symbols, numbers, and images which are changed over time and distinctive by an amount of the change over time; and the judging means uses a condition (g) instead of the condition (b), where the condition (g) is such that the obtained answer information indicates part of the elements included in the third unit images appearing through two holes or two transparent section of the authentication card when the authentication card is superimposed on the condition meeting random image.

Here, the third unit images are, for example, unit images made up of combinations of elements such as color and shape (triangle, rectangular shape, circle, star shape, or the like).

With the condition (g), the user is only requested to answer only part of the plural elements (e.g., one of color and the shapes). This reduces a burden on the user. Furthermore, even if the answer information is eavesdropped, it is more difficult to find out the secret positional pattern of the authentication card, because the answer information only indicates the part of the elements.

### BRIEF DESCRIPTION OF DRAWINGS

FIG. 1 is a block diagram illustrating a configuration of a server device according to Embodiment 1 of the present invention.

FIG. 2 is a block diagram illustrating an overall configuration of an authenticating system of the present invention.

FIG. 3 is a view illustrating a holed card according to Embodiment 1.

FIG. 4 is a block diagram illustrating a configuration of a terminal device according to Embodiment 1.

FIG. 5 is a flow chart illustrating a flow of a process performed by the authenticating system of Embodiment 1.

FIG. 6 is a view illustrating an example of a random image displayed on a display section of the terminal device.

FIG. 7 is a view illustrating a holed card and a display screen of the display section, where the holed card is overlapped on the random-image.

FIG. 8(a) is a view illustrating a first random image is displayed on a terminal device of Embodiment 2 and superimposed with a holed card.

FIG. 8(b) is a view illustrating a second random image is displayed on a terminal device of Embodiment 2 and superimposed with a holed card.

FIG. 8(c) is a view illustrating a third random image is displayed on a terminal device of Embodiment 2 and superimposed with a holed card.

FIG. 9(a) is a view illustrating holed cards held in a card holder according to Embodiment 3.

FIG. 9(b) is a view illustrating the card holder according to Embodiment 3.

FIG. 9(c) is a view illustrating the holed card according to Embodiment 3.

FIG. 10 is a block diagram illustrating an arrangement of a server device according to Embodiment 3.

FIG. 11 is a flow chart illustrating a flow of a process of an authenticating system according to Embodiment 3.

### REFERENCE NUMERALS

1•101: Server Device (Authenticating Device)
2: Terminal Device (Display Device, Input Device)
4: Holed Card (Authentication Card)
5: Holed Card (Sub Card)
13: Random Image Creating Section (Random Image Display Means)
14: Hole Pattern Storage Section (Positional Information Storage Section)
15•115: Condition Judging Section (Random Image Display Means)
16: Image Transmission Processing Section (Random Image Display Means)
17: Matching Section (Judging Means)
18: Authentication Judging Section (Authentication Control Means)
19: Positioning Sequence Creating Section (Relative Position Creating Means)
20: Common Hole Position Extracting Section (Common Position Extracting Means)
41: Hole
116: Image Transmission Processing Section (Random Image Display Means, Relative Position Display Means)

### BEST MODE FOR CARRYING OUT THE INVENTION

### Embodiment 1

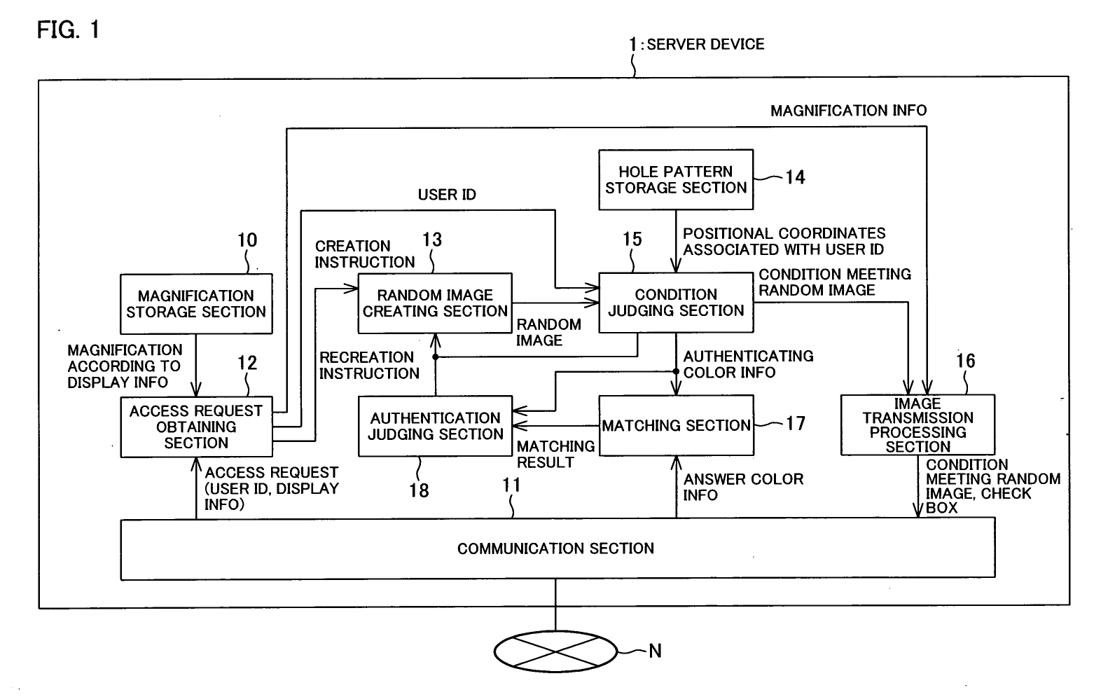

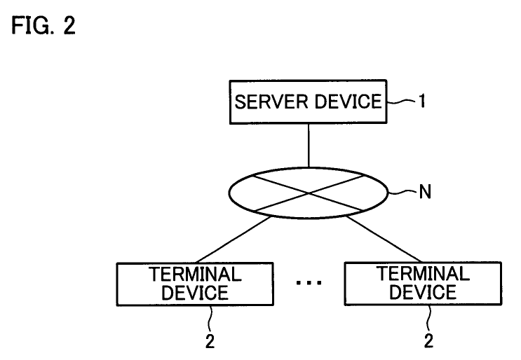

One embodiment of the present invention is described below referring to FIGS. 1 to 7. FIG. 2 is a block diagram illustrating an overall configuration of an authenticating system according to the present embodiment. As illustrated in FIG. 2, the authentication system of the present embodiment includes a server device (authenticating device) 1 and a terminal device (display device and input device) 2, which can communication with each other via a communication network N.

The communication network N may be the Internet, Intranet, Extranet, LAN, ISDN, VAN, CATV communication Network, a virtual private network, telephone line, mobile communication network, satellite communication network, or the like, and may be wired or wireless.

The user has been registered for use of the server device 1, and has a holed card (authentication card) specific to himself, and a user ID for identifying himself.

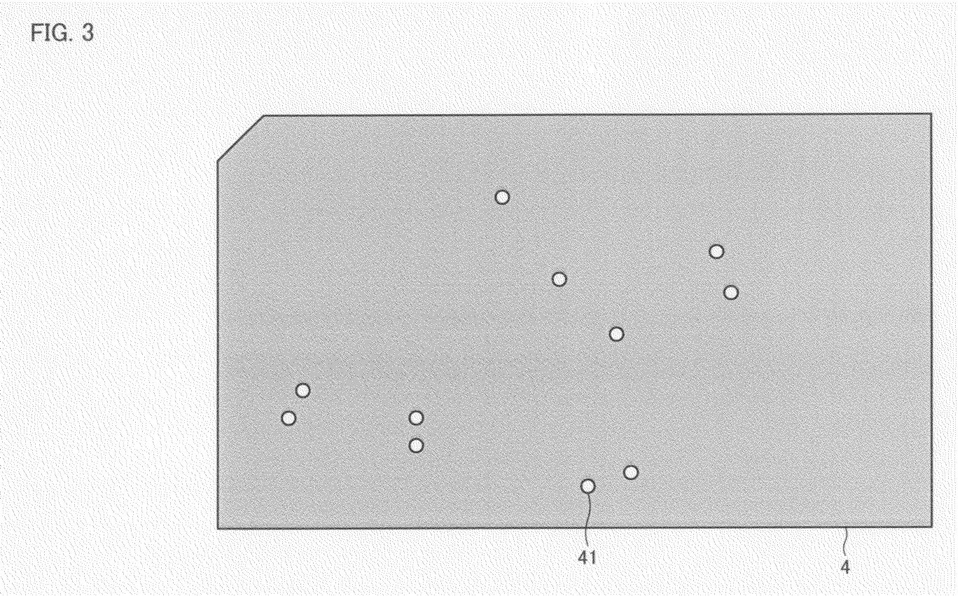

FIG. 3 is a view illustrating an example of a holed card (authentication card) 4. As illustrated in FIG. 3, the holed card 4 provided for the user himself is a plastic sheet having a predetermined shape (in this embodiment, a rectangular shape of a credit card size by way of example). The holed card 4 has a predetermined number of holes 41 (in this embodiment, eleven holes 41 by way of example). Moreover, the holed card 4 is black in color except the holes 41. Furthermore, positions of the holes 41 are identified with a row number and a column number of a matrix dividing the holed card with 25 rows and 40 columns.

Moreover, an edge (a left upper corner in FIG. 3) of the holed card 4 is notched. The notching allows the user to identify two-dimensional directions, upside, and downside of the holed card 4.

The user superimposes the holed card 4 on a condition-meeting random image (which will be described later), which meets a predetermined condition and on which 16 colors are randomly arranged. Then, the user arbitrarily selects one of the colors, which appears through two of the holes 41, and inputs in the terminal device 2 the selected color as an answer color. The server device 1 performs authentication of the user, based on the answer color.

<Configuration of Server Device>

Next, the configuration of the server device 1 is described. FIG. 1 is a block diagram illustrating the configuration of the server device 1. As illustrated in FIG. 1, the server device 1 includes a communication section 11, a magnification storage section 10, an access request obtaining section 12, a random image creating section (random image display means) 13, a hole pattern storage section (positional information storage section) 14, a condition judging section (random image display means) 15, an image transmission processing section (random image display means) 16, a matching section (judging means) 17, and an authentication judging section (authentication control means) 18.

The communication section 11 has a function of performing communication with the terminal device 2 via the communication network N.

The magnification storage section 10 has a function of storing display information and magnification of a random image in association with each other. The display information indicates a type (e.g., 14-inch, 17-inch, or the like) and resolution (e.g., 800×600 pixels, 1024×768 pixels, or the like) of the display section of the terminal device 2. The magnification indicates how much the random image should be magnified to the size of the holed card 4 in displaying the random image on the display section of the terminal device 2.

The access request obtaining section 12 has a function of acquiring an access request from the terminal device 2 via the communication section 11. The access request carries the user ID given to each user respectively, and the display information that indicates the type and resolution of the display section of the terminal device 2 that the user uses.

The access request obtaining section 12 reads out the magnification from the magnification storage section 10 according to the display information included in the access request.

In case where the access request obtaining section 12 receives an access request including display information that is not stored in the magnification storage section 10, the access request obtaining section 12 acquires a most appropriate magnification from the terminal device 2. More specifically, the access request obtaining section 12 transmits a sample image and a magnification setting instruction to the terminal device 2, the sample image having the same size of the random image of the magnification 1. Then, the user inputs in the terminal device 2 a magnification of the sample image to the size of the holed card. The access request obtaining section 12 acquires the magnification inputted to the terminal device 2.

The access request obtaining section 12 outputs the magnification to the image transmission processing section 16, the magnification being read out from the magnification storage section 10 or acquired from the terminal device 2.

Moreover, after the access request obtaining section 12 obtains the access request, the access request obtaining section 12 outputs to the condition judging section 15 the user ID attached to the access request, and outputs a creation instruction to the random image creating section 13.

The random image creating section 13 has a function of creating a random image in which 1000 areas segmented with 25 rows and 40 columns are independently colored with a color randomly selected from predetermined 16 colors. That is, the 1000 areas are constituted of unit images which are randomly colored with any of the predetermined 16 colors in such a manner that one unit image is colored with one color. The random image creating section 13 outputs the created random image to the condition judging section 15.

The hole pattern storage section 14 has a function of storing the user ID and the positional coordinates of the eleven holes 41 of the holed card 4 provided to the user (i.e., positional coordinates of the secret positional pattern) in association with each other. The positional coordinates indicate the column numbers and the row numbers of positions at which the holes 41 are formed. Table 1 is a table, which gives an example of the information stored in the hole pattern storage section 14. As illustrated in Table 1, for example, the hole pattern storage section 14 stores a user ID “XXX” in association with positional coordinates (4,1), (12, 1) . . . (22, 25) of the holes 41 of the holed card 4 provided to the user. Here, the first number in the parenthesis is the column number, while the second number therein is the row number.

TABLE 1

| User ID | Positional Information |
|---|---|
| XXX | (4, 1), (12, 1), . . . , (22, 25) |
| . | . |
| . | . |
| . | . |

The condition judging section 15 has a function of judging whether or not a particular color on the random image outputted from the random image creating section 13 meets a predetermined condition (a)t the positions of the holes 41 of the holed card 4 of the user, who is being subjected to the authentication.

The condition judging section 15 reads from the hole pattern storage section 14 the positional coordinates of the holes 41 of the holed card 4 in association with the user ID informed from the access request obtaining section 12. Furthermore, the condition judging section 15 extracts which color the random image received from the random image creating section 13 has at the read-out positional coordinates at which the holes 41 are located. Then, the condition judging section 15 judges whether or not the combination of the colors meets a condition (a) described below.

If the condition (a) is met, the condition judging section 15 outputs the random image that meets the condition (a), to the image transmission processing section 16 as a condition-meeting random image. The condition judging section 15 also outputs particular color information to the matching section 17 and the authentication judging section 18, the particular color information indicating a particular color that satisfies the condition (a). On the other hand, if the condition (a) is not met, the condition judging section 15 outputs to the random image creating section 13 a recreating instruction, which instructs the random image creating section 13 to recreate random colors for the respective positional coordinates at which the holes 41 are located.

Condition (a): At least one color appears at just two hole positions, and no color appears at three or more hole positions out of the eleven hole position.

The image transmission processing section 16 receives the condition-meeting random image from the condition judging section 15 and magnifies the condition-meeting random image to the magnification informed from the access request obtaining section 12. Then, the image transmission processing section 16 transmits the magnified condition-meeting random image to the terminal device 2. Consequently, the display section of the terminal device 2 can display the condition-meeting random image of the same size as the holed card 4.

From the image transmission processing section 16, data of a check box via which the user answers the particular color that meets the condition (a) is transmitted to the terminal device 2 together with the condition-meeting random image.

The matching section 17 acquires the answer color information (answer information) transmitted from the terminal device 2 in response to the condition meeting random image data transmitted from the image transmission processing section 16. Then, in the following rule B, the matching section 17 matches the acquired answer with the particular color information outputted from the condition judging section 15. The matching section 17 outputs a result of the matching to the authentication judging section 18.

Rule B: if the answer color is the color that appears just at two hole positions, then it is judged that the answer color “matches” with the particular color information; if not, then it is judged that the answer color “does not match” with the particular color information.

The matching section 17 repeats the matching until a matching time (number of times the matching is performed) N of the matching section 17 satisfies an authentication judgment start condition (c). If the authentication judgment start condition (c) is satisfied, the authentication judging section 18 performs authentication on whether or not the matching result received from the matching section 17 meets the following rule D.

Authentication judgment start condition (c): the matching time N satisfies the following equation:

$$p = {\prod }_{n = 1}^{N} \frac{Num ( n )}{16} < \frac{1}{10000} . \qquad Equation 1$$

where Num (n) is a number of the particular colors in the condition meeting random image transmitted from the image transmission processing section n-thly.

Rule D: if the matching results are “matched” N times continuously, then it is judged that the authentication is successful; if one or more of the N time repeated matching results are “not matched”, then it is judged that the authentication is failed.

That is, referring to the particular color information received from the condition judging section 15, the authentication judging section 18 extracts Num(n), which is the number of the particular colors in the condition meeting random image transmitted to the terminal device 2. Then, the authentication judging section 18 performs such a multiplication that Num(1)/16× . . . ×Num(N)/16, where Num(n)/16 is a possibility that a color randomly inputted by a third party without the authentication card matches with the particular color. A minimum N, which gives a result of 1/10000 or less in the multiplication, is put as the matching time necessary to start the authentication judgment If the matching results are “matched” N times continuously, the authentication judging section 18 judges that authentication is successful. If one or more of the N time repeated matching results are “not matched”, the authentication judging section 18 judges that authentication fails.

<Configuration of Terminal Device>

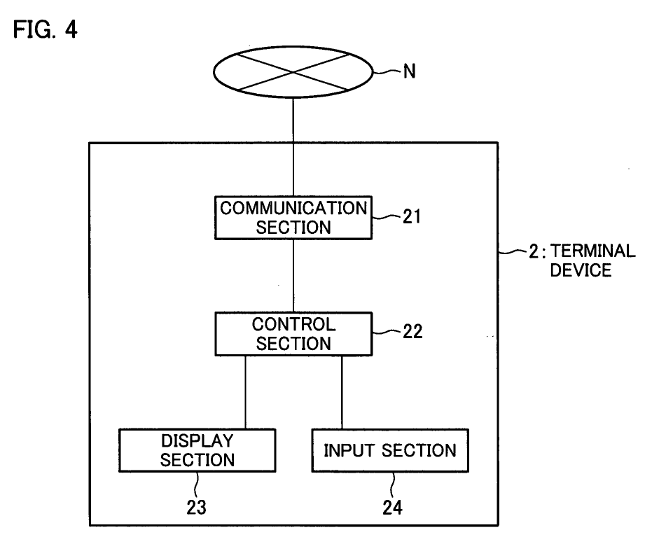

Next, the configuration of the terminal device 2 is described. As illustrated in FIG. 4, the terminal device 2 includes a communication section (random image obtaining means, input information transmitting means) 21, a control section (random image acquiring means, input information transmitting means, display means) 22, a display section (display means) 23, and an input section 24. The terminal device 2 is a device having a display function and an input function.

The communication section 21 has a function of communicating with the server device 1 via the communication network N. The display section 23 is, for example, a liquid crystal display device. Moreover, the input section 24 includes, for example, a keyboard, ten keys, or mouse. A mobile phone having a display section may be the terminal device 2.

The control section 22 has a function of controlling the communication section 21, the display section 23, and the input section 24 according to various instructions received from the server device 1 via the communication network N and the communication section 21, or according to various instructions inputted via the input section 24.

In response to the access request instruction inputted in the input section 24, the control section 22 causes the display section 23 to display an input instruction on the display section 23, thereby requesting an input of the user ID and the display information, which indicates the type and resolution of the display section 23 of the terminal device 2. Via the communication section 21, the control section 22 transmits to the server device 1 the access request to which the user ID and the display information inputted in the input section 24 are added.

As an alternative, the control section 22 may store display information regarding the display section 23 and add the display information to the access request. This does not require the user's input of the display information.

Moreover, if the server device 1 sends a magnification setting instruction thereto thereby instructing to set the magnification, the control section 22 causes the display section 23 to display (a) the image received from the server device 1 and (b) an input instruction to request an input of a magnification that magnifies the image to the same size of the holed card 4. Then, the control section 22 transmits, to the server device 1, the magnification inputted in the input section 24. The magnification instruction can be done by inputting numbers or using a mouse on the display device.

The control section 22 causes display of the condition meeting random image and check box transmitted from the server device 1.

The user puts the holed card 4 on the random image displayed on the display section 23, and confirms that at least one color appears through two of the eleven holes. Then, the user inputs the color in the input section 24 as the answer color. If there are two or more colors each of which appears through two holes, the user may input any one of the two or more colors.

The control section 22 transmits, to the server device 1, the answer color information (answer information) that indicates the answer color inputted in the input section 24.

<Flow of Authentication Process>

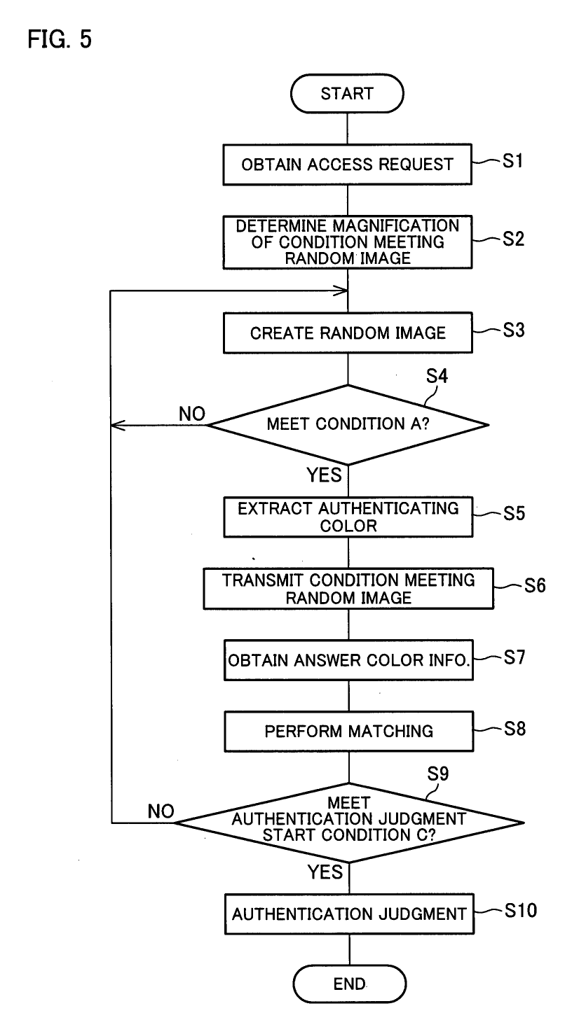

Next, a flow of the process of the authenticating system is described. FIG. 5 is a flow chart of the flow of the authenticating process of the present embodiment.

To begin with, the access request obtaining section 12 of the server device 1 obtains the access request from the terminal device 2, the access request carrying the user ID and the display information (S1).

Then, from the magnification storage section 10, the access request obtaining section 12 reads out the magnification that corresponds to the display information carried by the access request. The access request obtaining section 12 sets the read-out magnification as the magnification for the random image to be transmitted to the terminal device 2.

Here, if the display information carried by the access request is not stored in the magnification storage section 10, the access request obtaining section 12 transmits the sample image and the magnification input instruction to the terminal device 2. Then, the access request obtaining section 12 acquires the magnification that magnifies the sample image displayed on the display section 23 of the terminal device 2 to the same size as the holed card 4. The access request obtaining section 12 sets the acquired magnification as the magnification for the condition meeting random image that is to be transmitted to the terminal device 2.

By this, the access request obtaining section 12 determines the magnification for the condition meeting random image to be transmitted to the terminal device 2 (S2). Then, the access request obtaining section 12 outputs the creation instruction to the random image creating section 13. The access request obtaining section 12 outputs to the condition judging section 15, the user ID being carried by the access request. Further, the access request obtaining section 12 outputs the determined magnification to the image transmission processing section 16.

Next, the random image creating section 13 creates the random image in which unit images independently colored with a color randomly selected from the predetermined 16 colors are arranged in 25 rows and 40 columns (S3).

After that, from the hole pattern storage section 14 the condition judging section 15 reads out those positional coordinates of the holes 41 of the holed card 4 which correspond to the user ID carried by the access request. From the random image created by the random image creating section 13, the condition judging section 15 extracts all colors present at the read-out positional coordinates. Then, based on the extracted colors, the condition judging section 15 judges whether the random image meets the condition (a) or not (S4).

If the random image does not meet the condition (a) (No at S4), the condition judging section 15 outputs the creation instruction to the random image creating section 13 thereby instructing the random image creating section 13 to create random unit images located at the respective positions of the holes 41. Then, the process returns to S3.

If the random image meets the condition (a) (Yes at S4), all the colors appearing through just two holes 41 are set as the particular colors by the condition judging section 15, which then outputs the particular color information to the matching section 17 and the authentication judging section 18 (S5), the particular color information indicating the particular color.

Further, the condition judging section 15 outputs the condition meeting random image satisfying the condition (a) to the image transmission processing section 16. Then, by the image transmission processing section 16, the condition meeting random image outputted from the condition judging section 15 is converted by the magnification determined at S2. The image transmission processing section 16 then transmits the converted condition meeting random image and the check box data to the terminal device 2 (S6).

By this, the control section 22 causes the display section 23 to display the condition meeting random image and the check box thereon in the terminal device 2.

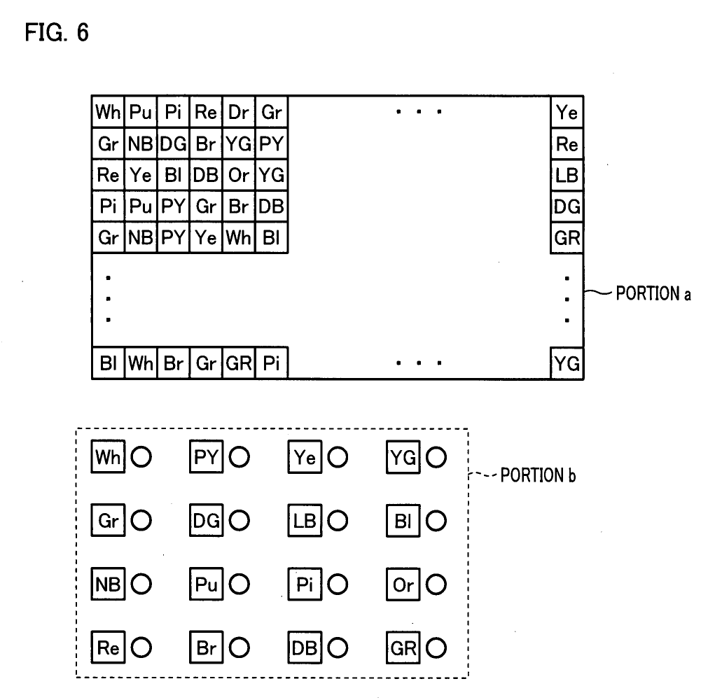

FIG. 6 is a view illustrating an example of a display displayed on the display section 23 of the terminal section 2 at S4. In FIG. 6, the part labeled with “Wh” is a unit image colored in white. Similarly, “PY” indicates a unit image colored in pale yellow. “Ye” indicates a unit image colored in yellow. “YG” indicates a unit image colored in yellow-green. “Gr” indicates a unit image colored in green. “DG” indicates a unit image colored in dark green. “LB” indicates a unit image colored in light blue. “Bl” indicates a unit image colored in blue. “NB” indicates a unit image colored in Navy Blue. “Pu” indicates a unit image colored in purple. “Pi” indicates a unit image colored in pink. “Or” indicates a unit image colored in orange. “Re” indicates a unit image colored in red. “Br” indicates a unit image colored in brown. “DB” indicates a unit image colored in dark brown. And, “GR” indicates a unit image colored in gray.

The portion a of FIG. 6 illustrates a condition meeting random image in which unit images single-colored with a color selected from the 16 colors arranged in 25 rows and 40 columns. Moreover, the portion b of FIG. 6 illustrates a check box.

Next, the user puts the holed card 4 on the condition meeting random image and confirms that an identical color appears through two holes 41. Then, the user ticks a check box of the color. The control section 22 regards the color of the check box ticked via the input section 24 as the answer color and transmits the answer color information that indicates the answer color. The server device 1 receives the answer color information, and the matching section 17 of the server 1 thereby acquires the answer color information (S7).

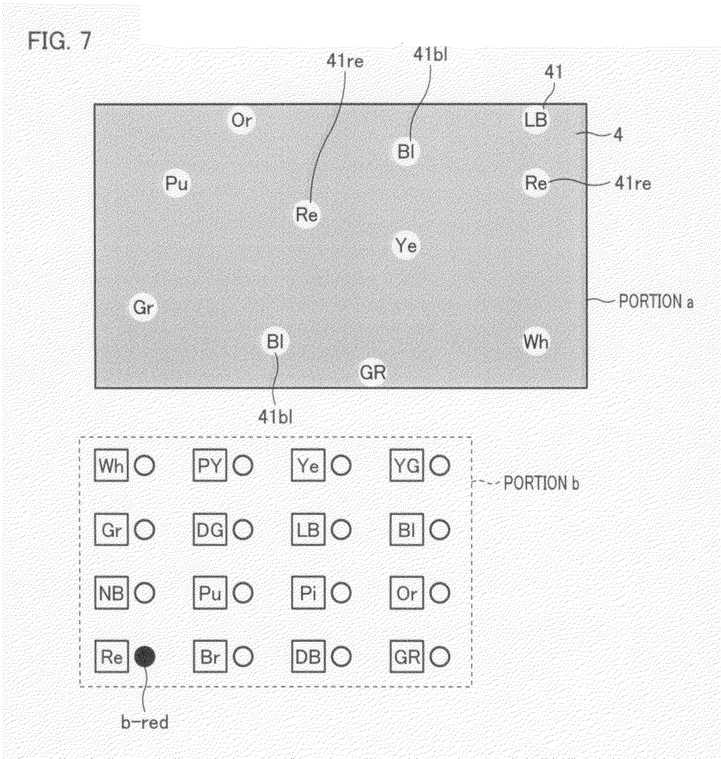

FIG. 7 is a view illustrating the random image and holed card 4 overlapping each other. When the holed card 4 is superimposed on the condition meeting random image as illustrated in the portion a of FIG. 7, the red color appears through two holes 41re and the blue color appears through two holes 41bl. In the rest of the holes 41, different colors appear. In this case, the user ticks check boxes of the red or blue color (in FIG. 7, the check box b-red for the red color) by using the input section 24.

Subsequently, the matching section 17 checks whether the particular color information matches with the answer color information. Then, the matching section 17 outputs the matching result (i.e., “matched” or “not matched”) to the authentication judging section 18 (S8).

The authentication judging section 18 receives the matching results and judges whether the matching time N from the reception of the access request meets the authentication judgment start condition (c) or not. For example as illustrated in FIG. 7, there is two particular colors in the first matching, the authentication judging section 18 calculates the equation 1, putting that Num(1)=2.

If the authentication judgment start condition (c) is not met (No at S9), the process returns to S3.

On the other hand, if the authentication judgment start condition (c) is met (Yes at S9), the authentication judging section 18 performs the authentication in which if the rule D is satisfied, that is, if all the matching results are “matched” continuously N times, the authentication is successful and if the rule D is not satisfied, that is, if one or more of the N time matching results are “not matched”, the authentication fails (S10). After this, the authentication process is ended.

As described above, the present embodiment performs the authentication by using the holed card 4 provided to the user specifically. The holed card 4 can be produced at much lower cost than the fingerprint reading device or the portable electronic computing device. The low cost of the holed card 4 allows to provide the user with holed cards 4 having different secret positional patterns every predetermined number of times the authorization card is used (or every predetermined period of service the authorization card is used, or every amount of money transaction the authorization card makes). In this way, the secret positional pattern of the holed card 4 provided to the user specifically is changed every predetermined number of times the holed card 4 is used. This makes it difficult for the eavesdropper to estimate the secret positional pattern even if the eavesdropper receives the communication.

Moreover, the holed cards 4 are distributed to the respective users. Thus, the user does not remember the positions of the holes 41.

On the other hand, the arts described in the Patent Citations 1 to 3, the user should remember the positions on the arrangement table in advance on which numbers are arranged. This limits the increases in the number of the rows, columns, and positions on the arrangement table. This is because the increase in the number of the rows, columns, and positions would make it easier for the user to forget the positions or remember a wrong position.

Therefore, for example assume that it is not possible to remember more than about 4 positions on an arrangement table of 10 rows and 10 columns. In this case, the total number of the secret positional pattern Num_key is:

₁₀₀C₄=100×99×98×97÷(4×3×2)=3921225

Let p_mispass is a possibility to succeed the authentication by randomly selecting the secret positional pattern, the possible secret positional pattern is reduced by p_mispass times when the authentication is eavesdropped once.

Moreover, there is a high possibility that the estimation reaches to one secret positional pattern after the authentication process is eavesdropped m times, where m is from an equation Num_key×(p_mispass)^{m}=1.

In the conventional examples,

NumKey=3921225

P_mispass= 1/10000

Thus, m is approximately 1.6. Thus, the estimation can reach to one secret positional pattern after eavesdropping the communication 1.6 times on average, presuming that there is an algorism to find out the secret pattern from the eavesdropped authentication process.

In the conventional examples, as described above, the eavesdropper could estimate the secret positional pattern by finding such a position on the arrangement table that a number identical with the inputted number appears every times, if the displayed arrangement table and the combination of the numbers inputted by the user referring to the arrangement table were leaked in plural times.

On the other hand, the present embodiment does not require the user to remember the positions of the holes 41 because the holed card 4 is provided to the user. Further, the information displayed through the holes 41 is only color. Thus, the holes 41 can be as small as possible, provided that the user can recognize the color. If the holes 41 are small in size, it is difficult to find out the positions of the holes 41 even by photographing the holed card 4, for example, with a video camera.

Moreover, because the information displayed through the holes 41 are only color, it is possible to reduce the number of dots that the display section 23 should allocate for each hole 41. As a result, it becomes easier to magnify or shrink the condition meeting random image, thereby making it possible to use various display devices.

Moreover, with such small-sized holes 41, it is possible to allow the condition meeting random image to have more rows and columns, and the holed card 4 to have a more number of holes.

For example, it is possible to use a holed card 4 having 11 to 1000 holes.

In this case, the total number of the secret positional patterns of the holes 4 can be worked out by:

Num_key=₁₀₀₀C₁₁.

From the equation, the total number is approximately 2.4×10²⁵.

Moreover, p_mispass is presumed to be 1/10000.

From this, the number m of the eavesdropping of the authentication necessary for estimating the secret pattern of the holes 41 to one secret pattern becomes approximately 6.2. This shows that the present invention reduces the possibility of finding the secret positional pattern of the holes 41 via eavesdropping compared with the conventional arts.

Moreover, the answer color transmitted from the terminal device 2 is decided based on the combinations of all the colors appearing through the 11 holes. That is, the answer color does not depend on the order of the holes: in a case the red color appears through the first and second holes, and in a case the red color appears through the fourth and eighth holes, the answer color is “red” in either case. Therefore, even if the random image transmitted from the server device 1 and the answer color for the random image are eavesdropped, the eavesdropper should face an immense number of combinations of the 11 holes, which requires a very complicate algorism for finding the secret positional pattern of the holes from the eavesdropped answer color and the condition meeting random image. Thus, it becomes difficult to find the secret positional pattern.

Moreover, the possibility that the random image created by the random image creating section 13 meets the condition (a) can be adjusted as appropriate, by changing the condition (a). If the possibility of meeting the condition (a) was too high, it would result in a high possibility that the user would mistake the fake server for the true server. If the possibility of meeting the condition (a) was too low, it would make it easy to estimate the secret positional pattern by eavesdropping the arrangement table.

For example, if the number of the colors used in the random image is 16, a possibility that a certain color appears through 3 or more of the 11 holes is approximately 0.402, and a possibility that all the colors appearing through the holes are different is approximately 0.010. Thus, the condition (a) is met at a possibility that 1−(0.402+0.010)=0.588.

Moreover, the fake server faking the server device 1 is not provided with the secret positional pattern. This increases a possibility that the fake server device provides a random image unsatisfying the condition (a) while the authentication process is performed plural times. For example, the same color would appear through three holes, or no color would appear through two holes.

A possibility that the fake server device faking the server device 1 is found out as a fake one by the user via one authentication process is 0.412. When the authentication process is repeated 6 times, a possibility that the fake server device is not found out as a fake one is (1−0.412) 6=0.070.

Furthermore, it is not possible to make it easy to meet the condition (a) by increasing or reducing the number of colors used by the fake server device from 16. The increase in the number of colors would reduce the possibility that a color appears through two holes, while the decrease in the number of the colors would increase the possibility that a color appears through three holes.

The increase in the number of holes increases the numbers of the secret positional patterns of the holes 41, thereby improving the security. However, the increase in the number of holes put more burden on the user to check the holes visually. Moreover, the increase in the number of holes requires an increase in the number of the color in order to keep the condition (a) workable, thereby making it difficult to compare the colors visually. In view of this, black color (that is, the same color (background color) as the part of the holed card 4 which the holes 41 are not formed) may be used in addition to the 16 colors. In this case, the black color is ignored in the judgment of the condition (a). By blackening a significant population (e.g., ⅓) of the whole unit images appearing on the random image, it is possible to reduce the number of holes through which colors other than black appear. By this, it is possible to allow the user to visually check the particular color without a more burden even if the number of holes is increased.

Moreover, the present embodiment is arranged such that the authentication judging section 18 repeats the transmission and matching of the random image until the matching is performed a number of time that satisfies the authentication judgment start condition (c). By this, the possibility that a false user passes the authentication by random input can be kept below a certain level even if the number of the particular color is changed per random image.

Furthermore, this arrangement does not allow the false user to find out which time the false user inputted such an input that was judged as being “not matched”. This improves the security.

However, the number of matching times in the authentication judgment starting condition (c) may be set in advance. For example, if the number of colors used is 16, and the number of holes in the holed card 4 is 11, the expected value of the number of the colors appearing through two holes is approximately 1.92. That is, the possibility that the randomly inputted color is matched with the particular color in one matching process is 1.92/16=0.12. Thus, the possibility that the randomly inputted color is judged as being “matched” can be reduced to 2.99×10⁻⁶ by arranging such that the number of matching times is 6.

Moreover, the present embodiment is arranged such that the access request obtaining section 12 acquires the magnification from the terminal device 2 if the display information carried by the access request is not found in the magnification storage section 10. In one more preferably arrangement, the access request obtaining section 12 stores a magnification in association with the user ID once the access request obtaining section 12 obtains the magnification, so that in response to second or later access requests, the access request obtaining section 12 determines the magnification associated with the user ID to the magnification for the random image to be transmitted. This eliminates the need of inputting the magnification thereby making it more convenient.

Moreover, the holed card 4 is superimposed on the display section 23 when the holed card 4 is used in the authentication process. In this case, it is preferable that there is no gap between the holed card 4 and the screen of the display section 23. In view of this, the holed card 4 may be made of a material that easily electrified statically. As an alternative, a back surface of the holed card 4 may be coated with a sticky material. These arrangements stick the holed card 4 on the display section 23 thereby eliminating the gap therebetween. Consequently, it becomes easier for the user to check the unit images appearing through the holes 41.

### Embodiment 2

The present invention is not limited to Embodiment 1 in which as the random image, only one condition meeting random is transmitted to the terminal device 2 per authentication process. A server device 1 may transmit two or more (e.g., 3) random images to a terminal device 2 per authentication process.

In the present embodiment, the server device 1 transmits a combination of plural random images to the terminal device 2 per authentication process. At least one of the random images is put as a condition meeting random image satisfying the condition (a). A color on any one of the condition meeting random images transmitted to the terminal device 2 is informed as an answer color to the server device 1. Then, the server device 1 performs the authentication using the answer color.

The holed card 4 has eleven holes 41 at positions specific to the user, like in Embodiment 1.

Configurations of the server device 1 and the terminal device 2, and a process procedure in the present embodiment are similar to those illustrated in FIGS. 1 and 5. Thus, only differences therebetween is explained here, omitting detailed explanation.

A random image creating section 13 of the present embodiment creates three random images when it receives a creation instruction or recreation instruction. Here, the random image creating section 13 uses 8 colors (except the black color) to color unit images. Some unit images are colored with none of the 8 colors and will be ignored in the judgment on the condition (a) (that is, some unit images are in black (unit images in the same color as the color (background color) of the portion of the holed card 4 in which no hole 41 is formed).

Here, it may be arranged that a ratio of the black unit images is greater than the other unit images in the random image (e.g., ¾ of the unit images in the random image are the black unit images). By this, it becomes easy for the user to make a judgment regarding the condition (a). This allows the holed card to have a more number of holes.

Moreover, the condition judging section 15 of the present embodiment judges whether the respective three random images generated by the random image creating section 13 satisfy the condition (a) or not. If any of the random images satisfies the condition (a), the condition judging section 15 outputs the three random images to the image transmission processing section 16. Meanwhile, the condition judging section 15 extracts all the particular colors from all condition meeting random images that satisfy the condition (a), and outputs particular color information indicating the extracted particular colors to the matching section 17 and the authentication judging section 18.

Among the random images transmitted to the image transmission processing section 16 from the condition judging section 15, one or more random images would be a random image(s) that does(do) not satisfy the condition (a).

Further, the image transmission processing section 16 of the present embodiment repeats the transmission such that the three random images are transmitted in an order with certain intervals, the three random images having been transited thereto from the condition judging section 15.

By this, the display section 23 of the terminal device 2 displays the first random image, the second random image, and the third random image repeatedly displayed with the certain intervals. The user puts the holed card 4 on the random images displayed on the display section 23 thereby check which color appears in each interval through the holes 41 provided in the number of 11.

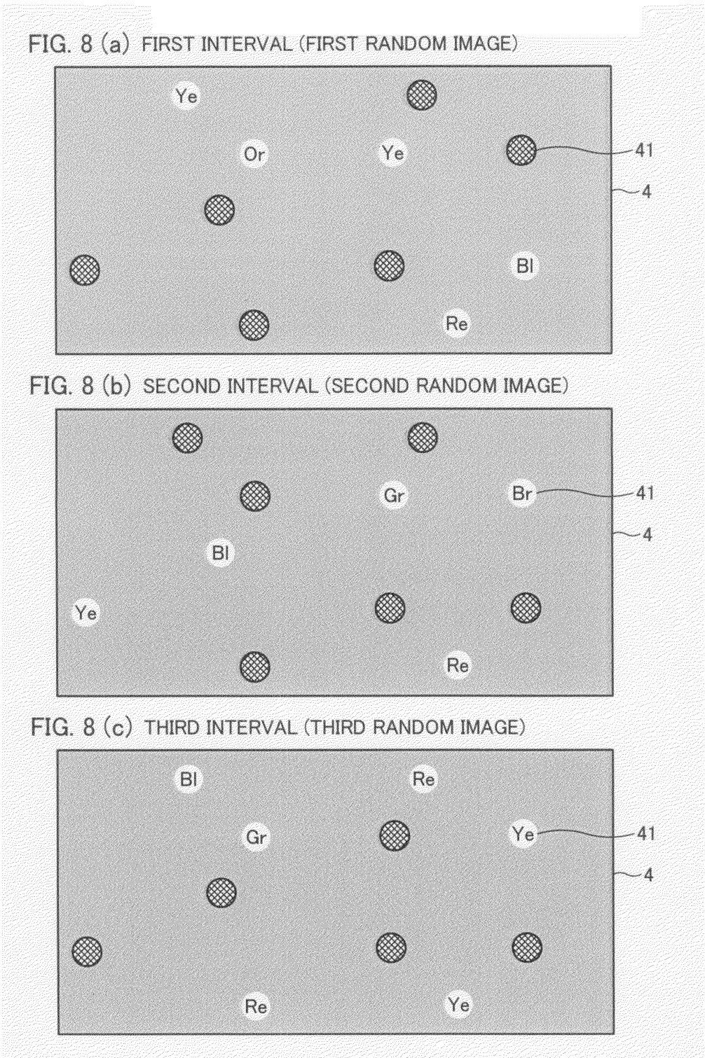

FIGS. 8(a) to 8(c) are views illustrating holed cards 4 and the random images displayed on the display section 23, where the holed cards 4 are superimposed on the random images. FIG. 8(a) illustrates the first random image displayed in a first interval. FIG. 8(b) illustrates the second random image displayed in a second interval. FIG. 8(c) illustrates the third random image displayed in a third interval. In FIG. 8, the hatched portions indicate black unit images, that is, unit images that is colored with none of the 8 colors used to color the other unit images. The control section 22 displays on the display section 23 an input instruction for requesting an input of a color appearing through two holes 41 in the random image displayed in one of the intervals. Then, the control section 22 transmits answer color information to the server device 1, the answer color information indicating an answer color inputted via the input section 24.

As illustrated in FIG. 8(a), yellow (indicated as “Ye” in FIG. 8(a)) appears through two holes 41 in the first random image. Moreover, as illustrated in FIG. 8(b), no color appears through two holes 41 in the second random image. Further, yellow and red (indicated as “Re” in FIG. 8(c)) appear through two holes 41 in the third random image. That is, the first and the third random images are condition meeting random images that satisfy the condition (a). In this case, the user can input the yellow or red as the answer color.

The authentication judging section 18 of the server device 1 performs the authentication based on the matching results of matching performed N times, which satisfies the authentication judgment start condition (c).

According to the present embodiment, even if the three random images, at least one of which is the condition meeting random image, and the answer color information are eavesdropped, it is impossible to find out which random image the answer color information refers to. Thus, it is more difficult to estimate the positions of the holes 41 of the holed card 4 that the user owns. This attains higher security.

Moreover, the present embodiment is arranged such that the image transmission processing section 16 transmits to the terminal device 2 the three random images in the order with the certain intervals repeatedly. This allows the user to input the answer color while keeping the superimposing card in the same position on the display section 23.

However, if the display section 23 has a size that is large enough to display the three random images of the same size as the holed card 4 together at the same time, it may be arranged such that the image transmission processing section 16 transmits the three random images at the same time and the control section 22 displays the three random images on different areas of the display section 23 without overlapping each other. In this arrangement, the user should superimpose the holed card 4 on each random image, but the random image does not change with the intervals. Thus, the user can check the color appearing through the holes 41 without caring the change over time.

### Embodiment 3

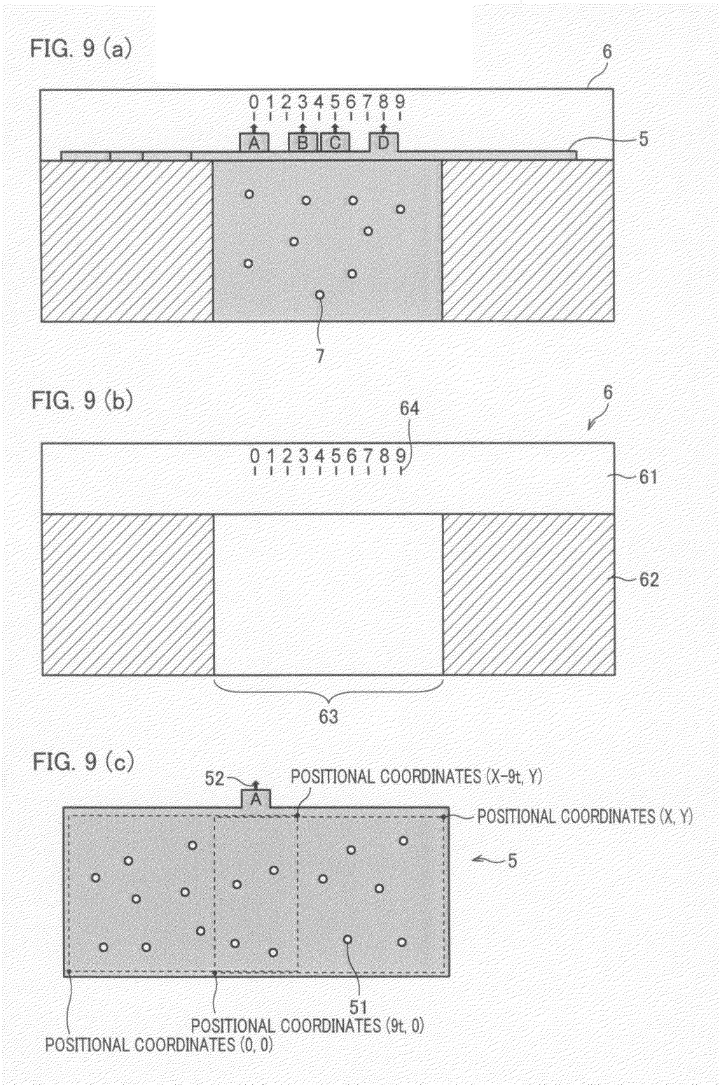

Still another embodiment to the present invention is described below referring to FIGS. 9 to 11. For easy explanation, sections having the same functions as those illustrated in the figures referred in Embodiment 1 are labeled in the same manner and their explanation is omitted here.

The present embodiment is arranged such that a user owns plural holed card (sub cards) and stacks the a plurality of holed cards in certain positions, and uses plural holes common to all the holed card in order to perform authentication similar to the one performed in Embodiment 1.

For example, each user is provided with holed cards (sub cards) 5 of four. These holed cards 5 are held in a card holder 6 in such a manner that they are stacked in the certain positions and movable sideways.

FIGS. 9(a) to 9(c) are views illustrating the holed cards 5 and the card holder 6 in the present embodiment. FIG. 9(a) illustrates a normal state in which the holed cards 5 are contained in the card holder 6. Meanwhile, FIG. 9(b) illustrates a card holder 6 from which the holed cards 5 are removed, and FIG. 9(c) illustrates one holed card 5 removed from the card holder 6.

As illustrated in FIGS. 9(a) to 9(c), each holed card 5 has an identification symbol (A, B, C, D) and a positioning projection section 52.

Moreover, the card holder 6 is provided with a pair of sheets 61 and 62 facing each other. The sheet 61 on the back is transparent in a whole surface, and the sheet 62 on the front is transparent only in a transparent region 63, which is of the same size as a random image transmitted from a server device 101.

The card holder 6 has a positioning scale 64. For example, the positioning scale 64 is a scale on which numbers from 0 to 9 are arranged with equal intervals.

Each holed card 5 is positioned between the sheets 61 and 62 of the card holder 6 in such a manner that the holed cards 5 are movable sideways.

The user can stacks the holed cards 5 in the certain relative position by positioning the positioning projection section 52 of each holed card 5 at a position of a number on the positioning scale 64 as instructed by information transmitted from the server device 101, the information associating the holed cards A to D with the numbers. Using (a) plural common holes 7 common to the stacked holed cards 5 and (b) the random image transmitted from the server device 101, the user performs the authentication similar to the one performed in Embodiment 1.

The stacking of the holed cards 5 of four has 10000 patterns (fourth power of 10 (the number of the scales of the positioning scale 64)). Moreover, the numbers of the holes of the holed cards 5 are more than that in Embodiment 1. The number of the common holes 7 may not be fixed, and may be varied according to how the holed cards 5 are stacked.

Moreover, the holed cards 5 are larger than the transparent region 63 of the card holder 6 sideways, so that the holed cards 5 can cover the whole transparent region 63 even if the holed cards 5 are slid sideways.

Positional coordinates of holes 51 of each holed card 5 are expressed in row and column numbers, and are from coordinates (0, 0) to (X, Y). When the positioning projection section 52 of the holed card 5 is positioned at the leftmost scale (here, the scale “0”) of the positioning scale 64, an area from coordinates (9t, 0) to (X, Y) corresponds to the transparent region 63 of the card holder 6. When the positioning projection section 52 of the holed card 5 is positioned at the rightmost scale (here, the scale “9”) of the positioning scale 64, an area from coordinates (0, 0) to (X−9t, Y) corresponds to the transparent region 63 of the card holder 6.

### <Configuration of Server Device>

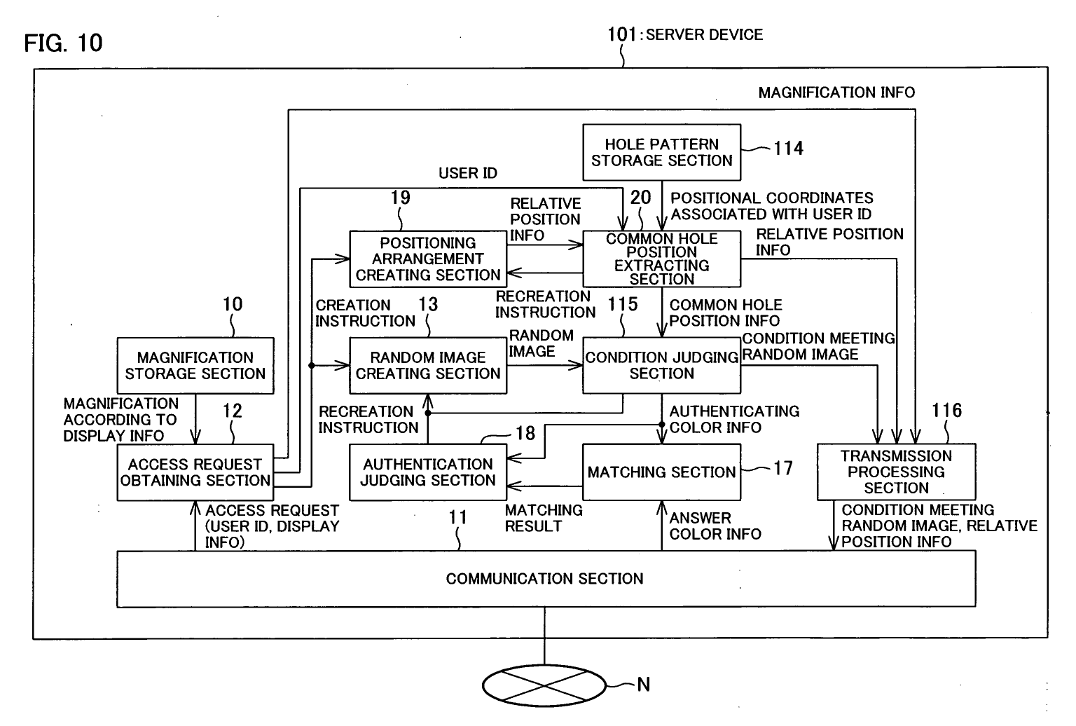

Next, the server device (authenticating device) 101 of the present embodiment is described. FIG. 10 is a block diagram illustrating a configuration of the server device 101.

The server device 101 of the present embodiment includes, as illustrated in FIG. 10, a communication section 11, a magnification storage section 10, an access request obtaining section 12, a random image creating section 13, a hole pattern storage section (sub position information storage section) 114, a positioning arrangement creating section (relative position creating means) 19, a common hole position extracting section (common position extracting means) 20, a condition judging section (random image display means) 115, a transmission processing section (random image display means, relative position display means) 116, a matching section 17, and an authentication judging section 18.

The hole pattern storage section 114 stores associations of the user ID and the positional coordinates of the holes 51 of all the holed card 5 of four provided to the user. The positional coordinates of the holes 51 are any of the coordinates (0, 0) to (X, Y).

Table 2 is a table illustrating an example of the information stored in the hole pattern storage section 114. As illustrated in Table 2, for example, the hole pattern storage section 114 stores the association of the user ID “XXX” and the positional coordinates of the holes 51 of the holed card A ((4, 1), (12, 1) . . . (42, 25)), the positional coordinates of the holes 51 of the holed card B, (1, 1), (4, 1) . . . (40, 25), the positional coordinates of the holes 51 of the holed card C ((3, 1), (5,1) . . . (44, 25)), and the positional coordinates of the holes 51 of the holed card D ((2, 1), (9,1) . . . (37, 25)). Here, the first number in the parenthesis is the column number and the second number therein is the row number.

TABLE 2

Positional Information

| USER ID | Card A | Card B | Card C | Card D |
|---|---|---|---|---|
| XXX | (4, 1) | (1, 1) | (3, 1) | (2, 1) |
| | (12, 1) | (4, 1) | (5, 1) | (9, 1) |
| | . | . | . | . |
| | . | . | . | . |
| | . | . | . | . |
| | (42, 25) | (40, 25) | (44, 25) | (37, 25) |
| . | . | . | . | . |
| . | . | . | . | . |
| . | . | . | . | . |

The positioning arrangement creating section 19 has a function of randomly creating a positioning arrangement that indicates which position in the card holder 6 the holed cards 5 of four provided to the user are to be arranged. That is, the positioning arrangement creating section 19 creates information regarding relative positions of the holed cards 5 of four when they are stacked.

More specifically, the positioning arrangement creating section 19 randomly creates numbers of the positioning scale 64 to which the positioning projection section 52 of the holed cards 5 (A to D) are to be positioned. The positioning arrangement creating section 19 outputs relative position information to the common hole position extracting section 20, the relative position information indicating the numbers of the positioning scale 64 which are created respectively for the holed cards A to D.

The common hole position extracting section 20 extracts the positional coordinates of the common holes 7 that are located at the same position on all the holed cards 5 when the holed cards 5 are stacked with the positioning scale 64 positioned according to the positioning created by the positioning arrangement section 19.

More specifically, the common hole position extracting section 20 reads out from the hole pattern storage section 114 the positional coordinates of the holes of the holed cards 5 of four (A to D) associated with the user ID.

Further, by the common hole position extracting section 20, the positional coordinates of the holes 51 read out from the holed pattern storage section 114 are adjusted based on the relative position information (which indicates the numbers of the positioning scale 64 which are created by the positioning arrangement creating section 19 for the respective holed cards 5). That is, the common hole position extracting section 20 adds (pt, 0) to the positional coordinates of the holed cards 5 where the holed cards 5 are to be positioned to p on the positioning scale 64.

From the adjusted positional coordinates of the holed cards 5 of four, the common hole position extracting section 20 judges whether a number of the common holes 7 common to all the holed cards 5 and positioned within the transparent region 63 of the card holder 6 is within a predetermined range, or not.

The adjusted positional coordinates are based on such positioning that the positioning projection section 52 of the holed card 5 is positioned to “0” on the positioning scale 64. As described above, the area from the coordinates (9t, 0) to (X, Y) corresponds to the transparent region 63 of the card holder 6, when the positioning projection section 52 is positioned at “0” on the positioning scale 64. Therefore, the common hole position extracting section 20 counts the common holes 7 located within the transparent region 63 of the card holder 6, taking the positional relationship between the area and the transparent region 63 into consideration.

If the number of the common holes 7 within the transparent region 63 is not within the predetermined range, the common hole position extracting section 20 outputs a creating instruction to the positional arrangement creating section 19, the creating instruction instructing recreation of the relative position information. Then, the common hole position extracting section 20 receives new relative position information from the positional arrangement creating section 19.

On the other hand, if the number of the common holes 7 within the transparent region 63 is within the predetermined range, the common hole position extracting section 20 extracts the positional coordinates of all the common holes from the adjusted positional coordinates, and outputs the extracted positional coordinates of all the common holes to the condition judging section 115, and outputs the relative position information to the transmission processing section 116.

The condition judging section 115 judges whether any combination of colors and the positional coordinates extracted by the common hole position extracting section 20 satisfies the condition (a) in a random image created by the random image creating section 13. If the condition (a) is satisfied, the condition judging section 115 outputs data of the condition meeting random image satisfying the condition (a) to the transmission processing section 116, and outputs particular color information to the matching section 17 and the authentication judging section 18, the particular color information indicating the particular color that satisfies the condition (a). On the other hand, if the condition (a) is not satisfied, the condition judging section 115 causes the random image creating section 13 to recreate a random image.

In addition of the function of the image transmission processing section 16 in Embodiment 1, the transmission processing section 116 has a function of transmitting to the terminal device 2 the relative position information that is outputted from the common hole position extracting section 20 and indicates the numbers on the positioning scale 64 at which the respective holed cards 5 are to be positioned. The relative position information is displayed on the terminal device 2, thereby letting the user know to which number on the positioning scale 64 the user should position the positioning projection sections 52 of the holed cards 5.

Moreover, according to magnification information, the transmission processing section 116 performs a magnification/shrinking process of the image including the condition meeting random image. Here, the transmission processing section 116 is arranged such that the image including the condition meeting random image is magnified/shrunk to the same size as the card holder 6 and that the transparent region 63 of the card holder 6 overlaps the condition meeting random image when the card holder 6 is superimposed on the image including the condition meeting random image.

As a result, the user can superimpose the transparent region 63 of the card holder 6 on the condition meeting random image by superimposing the card holder 6 on the image including the condition meeting random image displayed on the display section 23 of the terminal device 2.

### <Flow of Authentication Process>

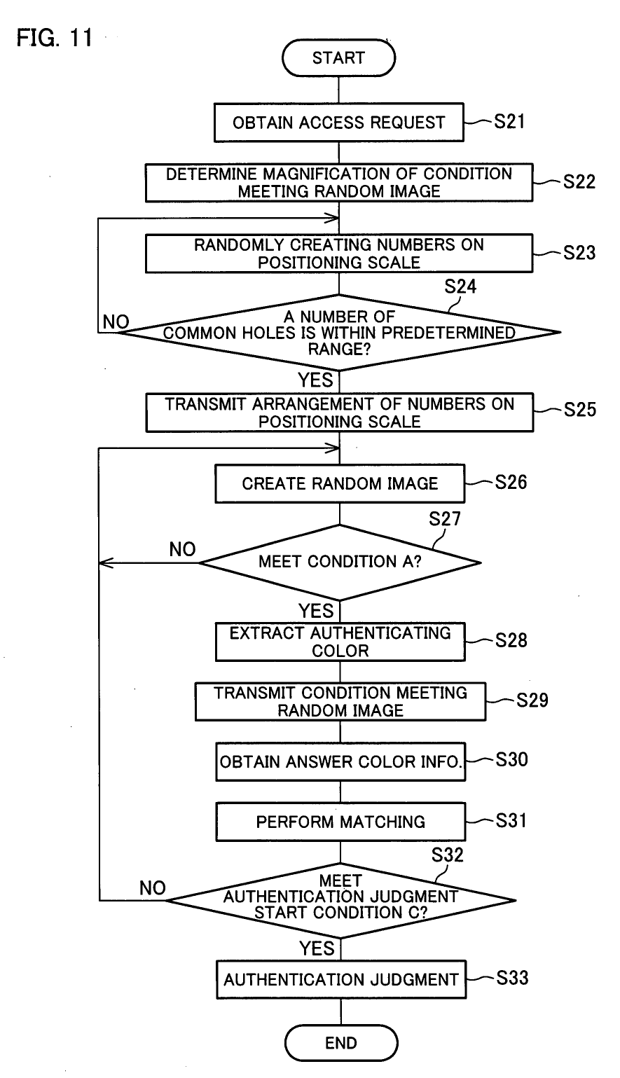

Next, a flow of the authentication process is described. FIG. 11 is a flow chart illustrating the flow of the authentication process of the present embodiment.

To begin with the access request obtaining section 12 obtains the access request (S21) and determines the magnification of the random image (S22), like S1 and S2 of FIG. 5 of Embodiment 1.

Next, the positioning arrangement creating section 19 randomly creates the numbers (relative position information) on the positioning scale 64 for the respective holed cards 5 of four (A to D), and then outputs the created number to the common hole position extracting section 20 (S23).

Next, the common hole position extracting section 20 reads out from the hole pattern storage section 114 the positional coordinates of the holes of the holed cards A to D associated with the user ID. Then, by the common hole position extracting section 20, the positional coordinates of the holes thus read out from the hole pattern storage section 114 are adjusted based on the numbers on the positioning scale 64, which are picked by the positioning arrangement creating section 19. After that, the common hole position extracting section 20 extracts the common holes 7 common to all the holed cards 5 and located within the transparent region 63 of the card holder 6, and judges whether the number of the common holes is within the predetermined range (S24).

If the number of the common holes is not within the predetermined range (No at S24), the process goes to S23.

On the other hand, if the number of the common holes is within the predetermined range (Yes at S24), the common hole position extracting section 20 outputs to the transmission processing section 116 the numbers (relative position information) on the positioning scale 64 for the respective holed cards 5 of four (A to D). Then, the transmission processing section 116 transmits the relative position information to the terminal device 2 via the communication section 11 (S25).

Here, the control section 22 of the terminal device 2 causes the display section 23 to display the relative position information acquired from the server device 101. This lets the user know at which number on the positioning scale 64 the user should position the positioning projection sections 52 of the respective holed card 5.

Next, the random image creating section 13 creates the random image (S26), similarly to S2 of FIG. 5 in Embodiment 1.

Next, from the random image created by the random image created section 13, the condition judging section 115 extracts all the colors at the positional coordinates of the common holes 7. Then, based on the extracted color, the condition judging section 115 judges whether or not the random image meets the condition (a) described in Embodiment 1 (S27).

If the condition (a) is not satisfied (No at S27), the condition judging section 115 outputs the creation instruction to the random image creating section 13, the creation instruction instructing the random image creating section 13 to create a random image again, and the process goes back to S26.

On the other hand, if the condition (a) is satisfied (Yes at S27), all the colors appearing through just two common holes 7 are set as the particular colors by the condition judging section 115. The condition judging section 115 outputs the particular color information to the matching section 17 and the authenticating judging section 18, the particular color information indicating the particular color thus set (S28). Further, the condition judging section 115 outputs the condition meeting random image data satisfying the condition (a) to the transmission processing section 116.

After that, the transmission processing section 116 performs the magnification/shrinkage process of the condition meeting random image according to the magnification acquired from the access request acquiring section 12, and transmits the processed condition meeting random image data and the check box data to the terminal device 2 (S29).

In this way, the user can stack the holed cards 5, respectively positioning the holed cards 5 at the numbers on the positioning scale 64, which are transmitted at S25, and ticks an answer color in the check box referring to the common holes 7, as in Embodiment 1.

The process from S30 to S33 is identical with that from S7 to S10 of FIG. 5 of Embodiment 1. Thus, their explanation is omitted here.

As described above, the present embodiment is arranged such that the plurality of holed cards 5 are stacked and positioned at positions randomly selected by the server device 101 per every authentication process, and that the authentication process is performed using the common holes common to all the holed cards 5. That is, the position of the common holes 7 are varied every authentication process. Moreover, there are 10000 patters of stacking the holed cards 5 of four. Even if the communication is eavesdropped, this makes it very difficult for the eavesdropper to estimate secret position patterns of the holed cards that the user owns.

Albeit the present embodiment is arranged such that the positioning arrangement creating section 19 performs the random creation of the numbers on the positioning scale 64 per authentication, the numbers may be created per matching process.

Moreover, the present invention is not limited to the present embodiment in which the server device 101 randomly creates the positions of the stacked holed cards 5, and transmits relative position information (here, the numbers on the positioning scale 64) of the stacking of the holed cards 5 to the terminal device 2 when the authentication is performed. The user may memorize the positions of the stacked holed cards 5.

That is, the user may memorize which number of the positioning scale 64 the holed cards 5 (A to D) are to be positioned respectively. Moreover, the hole pattern storage section 114 of the server device 101 records the association of the user ID and the numbers (relative position information) on the positioning scale 64 for the holed cards 5 (A to D). In this arrangement, the hole pattern storage section 114 acts as position information storage section for storing the positional coordinates (positional information) of the holes 51 of the holed cards 5, as well as the relative position storage section for storing the relative position information. Then, the common hole position extracting section 20 may extract the positional coordinates of the common holes 7 based on the numbers on the positioning scale 64, which the hole pattern storage section 114 records for the holed cards 5.

This arrangement will not let a thief to know at which position the stacked cards 5 are to be positioned, even if the holed cards 5 and the card holder 6 are stolen. False access to the server device 101 by using the stolen holed cards 5 and the card holder 6 is not possible.

In case where the fixed numbers on the positioning scale 64 is memorized by the user, the numbers indicating the relative positions of the stacked holed cards 5, the hole pattern storage section 114 may record the positional coordinates of the common holes 7 in advance.

Furthermore, it may be arranged such that the server device 101 designates the positions of part of the stacked holed cards 5, and the user memorizes the positions of the rest of the stacked holed cards 5. For example, it may be arranged such that holed cards 5 of eight (identification symbols A to H) and the server device 101 designates at which number on the positioning scale 64 the holed cards 5 of A to E are to be positioned, while the user memorizes in advance at which number on the positioning scale 64 the holed cards 5 of E to H are to be positioned. Even if the holed cards 5 and the card holder 6 are stolen, this prevents foul use of them and the positions of the common holes are varied in every authentication process.

[Modifications]

<Modification 1>

In Embodiments 1 to 3, the numbers of the columns and rows of the random images, the number of the colors used in the random image, and the number of the holes of the holed cards can be set within ranges preferable for the user's conveniences, difficulty in estimating the secret positional pattern, and the other factors.

Smaller numbers of the columns and rows of the random images make it possible to apply the present invention to a terminal device having a display section of small area.

Moreover, a greater number of the colors used in the random images will reduce the possibility that a color randomly inputted happens to match with the particular color. This allows reducing the number of repeating the checking for the authentication.

On the other hand, a greater number of the holes of the holed card increases the number of candidates of the secret positional patterns of the holes, thereby making it more difficult to analyze the secret positional pattern.

<Modification 2>

Moreover, the condition (a) is used in Embodiments 1 to 3. The present invention is, however, not limited to the condition (a) and may use various conditions, which may be varied according to the number of the colors used in the random image, and the number of holes of the holed card.

For example, the following conditions A-1 and A-2 may be applied.

Condition (a)-1: A certain particular color appears through approximately 30% of holes and another particular color appears through 10% or less of the holes.

The condition (a)-1 is effective in case where the number of columns and rows of the random images and the number of the colors used in the random images, and the number of the holes of the holed cards are large. This allows the user to easily judge which color the user should answer (i.e., which color is the answer color).

In case where the condition (a)-1 is applied, the random image creating section 13 creates a condition meeting random image that meets the condition (a)-1, but not an image of which the unit images are randomly arranged simply. Thus, the condition judging section 15/115 decides the particular color without judging whether the condition (a)-1 is met or not.

Condition (a)-2: A certain one particular color appears through two holes of the eleven holes, where all the colors do not appears three of the eleven holes.

In this case, only one color appears through two holes 41. Thus, the random image created by the fake server device will not meet the condition (a)-2 with a high possibility this increases the possibility that the user can find out that the server is the fake server device.

As an alternative, the checking section 17 of the server device 1/101 may perform the checking by the following rule B-1, instead of the rule B in Embodiments 1 to 3.

Rule B-1: If the particular colors and the answer color match completely, it is judged that the colors are “matched”; if not, it is judged that the colors are “not matched”.

In case where the rule B-1 is used, the user answers all colors appearing through two holes 41 as the answer colors. In this case, some condition meeting random images have plural answer colors from the user. Thus, it is possible to lower the possibility that a random answer by a fake user is authenticated successfully. The user is, however, required to answer all the colors appearing through two holes. This needs some time to find all the answer colors. Moreover, this slightly increases the possibility to estimate the secret positional pattern of the holed card 4 (or the pattern of the common holes 7 of the holed cards 5) if the plural answer colors are eavesdropped.

Moreover, the checking section of the server device 1/101 may perform the checking by using the following rule B-2 instead of the rule B in Embodiments 1 to 3.

Rule B-2: If the answer color is not identical with any of the particular colors, it is judged as “matched”; if the answer color is identical with any of the particular colors, it is judged as “not matched”.

That is, the checking section 17 judges as “matched” if the answer color is a color not appearing through some of the holes of the authentication card when the authentication card is superimposed on the condition meeting random image, that is, if the answer color is a color appearing through none or one of the holes of the authentication card.

Moreover, the following rule may be adopted instead of the rule D of Embodiments 1 to 3.

Rule D-1: it is judged that the authentication is successful, if the checking repeated times N results in “matched” at least N−1 times; if not, it is judged that the authentication is failed.

The rule D-1 takes user's errors in the input or in the color judgment into consideration. This does not require the user to repeat the authentication from the beginning, even if the user makes one error in the input or color judgment.

<Modification 3>

Embodiment 2 describes the arrangement in which the whole random images are changed periodically. Meanwhile, Embodiments 1 and 3 describe the arrangement in which the random image created by the random image creating section 13 is a still image. The present invention is not limited to these arrangements, and may be arranged such that the unit images of the random image are blinking. In case where the unit images are blinked, blinking intervals may be selected randomly from plural intervals. For example, the blinking intervals of the respective unit images may be selected randomly from “10 msec”, “100 msec”, and “1 sec”. By this, among “red” unit images, there are three kinds of blinking intervals.

In this case, the random image creating section 13 creates a random image in which the colors and blinking intervals of the unit images are randomly selected.

Moreover, the condition judging section 15/115 judges whether the following condition (a)-3 is met or not.

Condition (a)-3: One or more combinations of particular colors and blinking intervals of the authentication colors appear through two holes. There is no combination of authentication colors and blinking intervals thereof appearing through three or more holes.

As the answer, the user inputs a combination of the color and blinking intervals appearing through two holes. In this case, the server device transmits to the terminal device 2 check box image data for each color blinking at three kinds of intervals. By this, the user can easily input the combination of the color and the blinking intervals. The matching section 17 matches the combination of the particular color and blinking intervals thereof with the combination of the color and the blinking intervals thereof answered. If both the color and the blinking intervals are matched, the matching section 17 outputs a matching result “matched”.

As described above, the unit images are blinked at blinking intervals randomly selected from several kinds of predetermined blinking intervals, and the matching is carried out based on the particular color and the blinking intervals thereof meeting the condition (a)-3. In this arrangement, for example, there are three kinds of the blinking intervals, use of 5 colors gives 15 patterns in the combination of the colors and the blinking intervals. As such, the use of the blinking intervals can reduce the number of the colors used. This makes it easier for the user to distinguish the colors.

The present invention is not limited to the above example in which the plural kinds of the blinking intervals are used. Any combination of the color of the unit images of the random image and an element of a change over time in the unit images can be adopted. An example of such an element of a change over time is a color change in the unit images. For example, it may be arranged such that one unit image changes its color between red and blue at certain intervals, while another unit image changes its color between red and green at certain intervals, and the authentication is performed by using a combination of the colors changed at the intervals.

<Modification 4>

Further, the holed cards 4/5 may be arranged such that part of the holes has a colored transparent section, or a least one of the colorless transparent sections is a colored transparent section. For example, certain two holes of the 11 holes are provided with colored transparent filter of a certain color. By this, the user sees a color obtained by combining the color of the random image and the color of the colored transparent filter. On the other hand, through a hole provided with no colored transparent filter, the user sees the color of the random image. From the colors appearing through all the holes as such, the user answers, as the answer color, a particular color that meets the condition (a).

In this case, the server device includes a color information storage section for storing colored position information and color information in association with each other, the colored position information indicating where the colored transparent filter is provided, and the color information indicating the color of the colored transparent filter. Based on the color information, a random image in which particular color meets the predetermined condition is met, considering combinations of combination colors of the unit images with the colored transparent filter(s) provided thereat, and the color of the colored transparent filter(s), and the color of the unit images with no colored transparent filter(s) provided thereat.

The authentication judging section 18 performs the authentication based on the matching result of the answer color and the particular color.

By this, even if the random image and the answer color are eavesdropped, the eavesdropper cannot recognize whether the answer color is the color of the random image or the combination color of the color of the random image and the color of the colored transparent filter. As a result, it becomes very difficult to estimate the secret pattern of the holed card 4/5 and the color of each colored transparent filter.

<Other Modifications>

Moreover, if the size of the unit images of the random image and the size of the hole of the holed card 4/5 can be large enough, symbols, letters, numbers, pictures, or the like can be used instead of the colors. Moreover, combinations of these and colors may be used.

In case where combinations of the colors and numbers are used (that is, colored numbers are used), the following embodiments are possible. For example, assume that 8 colors and 10 numbers “0” to “9” are used in the unit images. Note that colored letters or colored figures may be used instead of colored numbers.

From among the colored numbers appearing through the holes, two numbers in a color appearing through two holes are extracted as authenticating numbers. The user inputs one of the numbers.

As an alternative, from among the colored numbers appearing through the holes, two colors of a number appearing through two holes. The user inputs one of the colors.

By this, only the number (or the color) is inputted. Thus, even if the inputted information is eavesdropped, it cannot be known by the eavesdropper what is the color (or the number) appearing through the two holes. This makes it more difficult to estimate the positions of the holes.

As an alternative, from the colored letter (or colored figure) appearing through two holes, the color or letter may be extracted as the authenticating information.

The matching section 17 judges as “matched” if the matching section 17 receives, as the answer information, the color or letter of the colored letter appearing through two holes of the authentication card superimposed on the condition meeting random image. By this, even if the answer information is eavesdropped, the answer information indicates part of the plural elements. This makes it more difficult to recognize the secret positional pattern of the authentication card.

Moreover, the random image and the holed cards 4/5 are not limited to rectangular shapes, and may have a round shape. If the random image and the holed cards are round, the arrangement as described in Embodiment 3 in which the plural holed cards 5 are stacked may be arranged such that the holed cards 5 are held rotatablly about their centers, making use of their round shape. This allows the stacked holed cards 5 to have the same size as the random image.

That is, the holed cards 5 can be stacked on each other at any relative position without reducing an area in which they overlap with each other. Thus, the holed cards 5 can be shifted largely. That is, the pattern of the relative positions can be increased.

Furthermore, the random image creating section 13 creates the random images and a random image(s) meeting the predetermined condition (e.g., the condition (a)) is determined as the condition meeting random image(s) by the condition judging section 15/115 from among the random images in Embodiments 1 to 3. Then, it is determined which condition meeting random image is to be transmitted to the terminal 2. The present invention is, however, not limited to such an arrangement and may be arranged such that an image creating means (random image creating means) for creating a condition meeting random image that meets the predetermined condition (e.g., the condition (a)) is provided.

For example, assume that the predetermined condition is the condition (a), the image creating means colors two unit images with a randomly selected color (this color will be the particular color), the two unit images corresponding to two holes 41 read from the hole pattern storage section 14 or the two common hole 7. Further, the image creating means colors other unit images with colors other than the particular color and different from each other, the other unit images corresponding to the rest of the holes 41 or of the common holes 7. Moreover, the image creating means colors the rest unit images with random colors, the rest unit images not corresponding to the holes 41 or the common holes 7. In this way, the image creating means can create a random image that meets the condition (a).

Moreover, in the case of Embodiments 1 and 2, the plural random images should include at least one condition meeting random image. The image creating means may create an arbitrary number of the condition meeting random images and create a number of the random images not meeting the condition (a), thereby making up the plural random images.

Moreover, Embodiment 2 may be preferably arranged such that the user is authenticated by an inputted password, in addition to the authentication described above. This reduces the possibility of the false use of the holed card, even if it is stolen.

In this case, the input of the password is preferably carried out after the authentication described in Embodiments 1 and 2. This is because the server device 1/101 is provided with the condition judging section 15/115, so that there is a possibility that the user can recognize the fake server device. Thus, by inputting the password after the authentication it is possible to reduce the possibility that the password is stolen by the fake server.

Even though the terminal device 2 and the server device 1/101 are connected vie the communication network N, the terminal device 2 and the server device 1/101 may be connected not via the communication network N. That is, the terminal device 2 and the server device 1/101 may be contained in the same housing and the terminal device is structured as a device having a display function and an input function.

Moreover, even though Embodiments 1 to 3 are arranged such that one terminal device 2 is used in the authentication. However, the authentication may be performed by using two terminal devices 2 (first and second terminal devices 2). For example, the first terminal device 2 sends an access request to the server device 1/101. Moreover, the server device 1/101 stores to which second terminal device 2 the image including the random table associated with the user ID is to be transmitted. The server device 1/101 transmits the image including the random table to the second terminal device 2. The user superimposes the card holder 6 on the image displayed on the second terminal device 2, the image including the random table. Then, the user finds an answer data string appearing through the common holes 7 and inputs the answer data string in the first terminal device 2. The server device 1/10 performs the authentication based on the answer data string obtained from the first terminal device 2. In this case, the first terminal device 2 acts as the input device, and the second terminal device 2 acts as the display device.

In this arrangement, the authentication uses two communication lines for transmitting the image including the random table and for transmitting the answer data string. This reduces the risk that both the random table and the answer data string are eavesdropped at the same time, thereby improving the security.

Moreover, the terminal device 2 in Embodiments 1 to 3 may be provided with a printer section (display means) for outputting the image on a medium (such as paper), instead of the display section 22 constituted by the display device or the like. In this case, the server device 1/101 creates plural condition meeting random images in association with the user ID, and stores information of the authenticating unit image that meets the predetermined condition, the information being associated with the respective images. The printer section of the terminal device 2 prints out the condition meeting random images in alignment. The user superimposes the holed card 4 or the card holder 6 on each image printing on the paper, thereby finding the type of the unit images that meets the predetermined condition. Then, the user inputs the information of the type of the unit images in the input section 24 of the terminal device 2.

Paper is easy to carry and provide, unlike the display device. For example, in case the user performs the authentication at a table in a restaurant, a staff of the restaurant inputs the user ID in the input section 24, and prints out the plural condition meeting random images on paper via the printer section. The staff then brings the paper to the table of the user. The user notifies the staff of the information of the authenticating unit images obtained from the condition meeting random images. The staff inputs the information in the input section 24 so as to transmit the information to the server device 1/101, which then performs the authentication of the information. This eliminates the need of bringing a device such as the display device or key board, which is difficult to carry, to the table. In this case, the unit images cannot be the unit images that changes over time. However, it is not necessary to adjust the magnification of the condition meeting random image.

Finally, each block of the server devices 1 and 101 may be constituted by hardware logic or software logic by using a CPU as follows.

That is, the server device 1/101 includes: (i) a CPU (central processing unit) for executing instructions of a control program realizing various functions; (ii) a ROM (read only memory) storing the above programs; (iii) a RAM (random access memory) for expanding the program; (iv) a storage device (recording medium), such as a memory, storing the programs and various types of data; and the like. Therefore, the object of the present invention can be achieved by: (i) providing, in the server device 1/101, a recording medium which stores a computer-readable program code (executable program, intermediate code program, a source program) of the control program for controlling the server device 1/101 that is software for realizing the functions, and (ii) causing a computer (CPU, or MPU) of the server device 1/101 to read out and execute the program code stored in the recording medium.

Examples of the recording medium encompass: tapes such as a magnetic tape and a cassette tape; magnetic disks such as a Floppy® disk and a hard disk; disks such as a CD-ROM (compact disk read only memory), a magnetic optical disk (MO), a mini disk (MD), a digital video disk (DVD), and a CD-Recordable (CD-R); and the like. Further, the storage medium may be: a card such as an IC card (inclusive of a memory card) or an optical card; a semiconductor memory such as a mask ROM, an EPROM (electrically programmable read only memory), an EEPROM (electrically erasable programmable read only memory), or a flash ROM; or the like.

Further, the server device 1/101 may be so arranged as to be connectable to a communication network, and the program code may be supplied to the server device 1/101 via the network. The communication network is not particularly limited. Specific examples thereof encompass: the Internet, intranet, extranet, LAN (local area network), ISDN (integrated services digital network), VAN (value added network), CATV (cable TV) communication network, virtual private network, telephone network, mobile communication network, satellite communication network, and the like. Further, a transmission medium constituting the communication network is not particularly limited. Specific examples thereof are: (i) a wired channel using an IEEE1394, a USB (universal serial bus), a power-line communication, a cable TV line, a telephone line, an ADSL line, or the like; or (ii) a wireless channel using IrDA, infrared rays used for a remote controller, Bluetooth®, IEEE802.11, HDR (High Data Rate), a mobile phone network, a satellite connection, a terrestrial digital network, or the like. Note that the present invention can be realized by a form of a computer data signal (a series of data signals) embedded in a carrier wave realized by electronic transmission of the program code.

### (Supplementary)

An authenticating device of the present invention may be expressed as follows: An authenticating device of the present invention is an authenticating device for authenticating a user via a display device and an input device, the device comprising (A) to (E): (A) a positional information storage section for storing positional information that indicates where holes or transparent sections are located on an authentication card which has the holes or transparent sections at positions specific to the user and a predetermined shape; (B) random image creating means for creating a condition meeting random image, wherein the condition meeting random image is a predetermined-shaped image, in which different kinds of unit images are randomly arranged, and in which a certain kind of unit images satisfy the predetermined condition (a)t plural positions indicated by the positional information read out from the positional information storage section; (C) random image display means for causing the display device to display the condition meeting random image generated by the random image creating means; (D) input information obtaining means for obtaining input information from the input device, the input information being inputted by the user based on a combination of unit images appearing through the holes or transparent sections when the authentication card is superimposed on the condition meeting random image displayed on the display device, and indicating a kind of unit images, which meets the predetermined condition in (B); and (E) authenticating means for authenticating the user based on a result of matching the information indicating the certain kind of the unit images in (B) with the input information.

With this arrangement, in which the authentication card has the holes or transparent sections in a way specific to the user, only the user having the authentication card can input the input information indicating the certain kind of the unit images. By this, it is possible to perform the authentication of the user.

Moreover, for example, the predetermined condition may be such that a kind of unit images appear through just two of 16 holes or transparent sections.

An authenticating device of the present invention is an authenticating device for authenticating a user via a display device and an input device, the device comprising (A) to (D): (A) random image creating means for creating a condition meeting random image in which different kinds of unit images are randomly arranged, and in which, when authentication cards having holes or transparent sections formed at plural positions in a way specific to the user are stacked and positioned in predetermined relative positions, a certain kind of unit images meet a predetermined condition (a)t positions of common holes or transparent sections common to all authentication cards; (B) random image display means for causing the display device to display the condition meeting random image created by the random image creating means; (C) input information obtaining means for obtaining input information from the input device, the input information being inputted by the user based on a combination of unit images appearing through the common holes or transparent sections when the authentication cards stacked and positioned at the relative positions is superimposed on the predetermined-shaped condition meeting random image displayed on the display device, and indicating a kind of unit images, which meets the predetermined condition in (A); and (D) authenticating means for authenticating the user based on a result of matching the information indicating the certain kind of the unit images in (A) with the input information.

Furthermore, the random image generating means may be arranged such that a combination of unit images at the positions indicated by the positional information read out from the positional information storage section is used as a combination for proving correctness of the authenticating device. With this, the user can judge whether the authenticating device is true or not, based on the combination of the unit images appearing through the holes or transparent sections of the authentication card.

Furthermore, the authenticating device may be arranged such that the random image creating means creates a group of plural random images in which different kinds of unit images are randomly arranged, at least one of the plural random images being a condition meeting random image that meets the predetermined condition and the input information obtaining means obtains the input information that is inputted by the user based on any one of the condition meeting random images among the random images displayed on the display device. This arrangement makes it impossible to know on which random image the input of the input information is based, even if the plural random images and the input information are eavesdropped. This makes it very difficult to estimate the positions of the holes or transparent sections of the authentication card.

The display of the plural random images may be repeated periodically to show them with intervals, or may be performed to display all the random images at once in alignment.

The display device and the input device may be integrated or not integrated. Moreover, the display device may be provided with a display section such as a display or the like, or may be such a display device that displays the image by printing out the image on a medium such as paper.

Moreover, an authenticating card of the present invention, which is an authenticating card for use in authenticating a user and has holes or transparent sections at positions specific to the user, may be made of a material that is statically electrifiable.

Moreover, the authenticating card of the present invention, which is an authenticating card for use in authenticating a user and has holes or transparent sections at positions specific to the user, may be arranged such that a back surface thereof is coated with a sticky material.

With this, the authentication card is superimposed on the condition meeting random image displayed on the display device with no gap therebetween. This makes it easier for the user to visually check the unit images through the holes or transparent sections of the authentication card.

The authenticating device or a display input system may be realized by a computer. In this case, the present invention encompasses an authenticating program for use in the authenticating device or the display input system, the program causing a computer to operate as each means described above so as to realize the authenticating device or the display input system by the computer, and a computer readable recording medium.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present invention can provide a high security at a very low cost. Thus, the present invention is applicable to authentication systems of security access control systems of computers and networks, especially client-server network architecture, hardware peer-to-peer architecture, and other architectures.

1. An authenticating device for authenticating a user by using a display device, an input device, and an authentication card in which holes or transparent sections are arranged at plural positions in a way specific to the user, the device comprising (A) to (C):
(A) random image display means for creating a condition meeting random image and causing the display device to display the condition meeting random image, the condition meeting random image including colored unit images being colored with various colors and randomly arranged therein in such a way that meets a condition (a),
where the condition (a) is such that at least one pair of the colored unit images of the same color appears through two holes or two transparent sections when the authentication card is superimposed on the condition meeting random image,
(B) judging means for obtaining, from the input device, answer information indicating one of the colors, and for judging whether the color indicated by the obtained answer information meets a condition (b),
where the condition (b) is such that the color indicated by the obtained answer information is one of the color(s) of the at least one pair of the colored unit images appearing through the two holes or two transparent sections when the authentication card is superimposed on the condition meeting random image,
(C) authentication control means for performing such authentication that the authentication is successful if the judging means repeats the judging process RN times and judges that the answer information meets the condition (b) in all the RN-time judging processes, where RN meets a condition (c) or (d),
where the condition (c) is such that (G₁/CN)×(G₂/CN)× . . . ×(G_{RN}/CN)≦a predetermined value, where CN is a number of the plural colors, and Gi is a number of pairs of colored unit images of the same color appearing through two of the holes or the transparent sections when the authentication card is superimposed on the condition meeting random image at an i-th judging process, and
where the condition (d) is such that (G/CN)RN≦a predetermined value, where CN is the number of the plural colors, and G is an expected value of the number of pairs of the colored unit images of the same color appearing through the two of the holes or the transparent sections when the authentication card is superimposed on the condition meeting random image.

2. The authenticating device as set forth in claim 1, wherein the condition meeting random image caused to be displayed by the random image display means meets a condition (e) in addition to the condition (a),
where the condition (e) is such that colored unit images of a color do not appears through three or more holes or transparent sections when the authentication card is superimposed on the condition meeting random image.

3. The authenticating device as set forth in claim 1, comprising:
a positional information storage section for storing positional information in association with the user, the positional information indicating where the holes or transparent sections are located on the authentication card,
the random image display means performing the creation of the condition meeting random image, based on positional information associated with the user to be authenticated, and
the judging means performing the judging process, based on positional information associated with the user who requests the authentication.

4. The authenticating device as set forth in claim 1, wherein:
the authentication card including sub cards in which holes or transparent sections are arranged at plural positions in a way specific to the user, the sub cards being changeable in their relative positions by sliding; and
holes or transparent sections common to all the sub cards stacked and positioned respectively at certain relative positions are used as the holes or the transparent sections of the authentication card.

5. The authenticating device as set forth in claim 4, further comprising:
(E) a sub positional information storage section for storing sub positional information in association with the user, the sub positional information indicating where the holes or transparent sections are located on the sub cards; and
(F) common position extracting means for reading out, from the sub positional information storage section, sub positional information associated with a user to be authenticated, and for extracting common positions based on the read-out sub positional information, the common positions being positions where the holes or transparent sections common to all the sub cards are located when the sub cards are stacked and relatively positioned at the certain relative positions,
the random image display means performing the creation of the condition meeting random image, based on the common positions extracted by the common position extracting means, and
the judging means performing the judging process based on the common positions extracted by the common position extracting means.

6. The authenticating device as set forth in claim 5, further comprising:
(G) relative position creating means for creating the relative positions of the sub cards per authentication; and
(H) relative position displaying means for causing the display device to display the relative positions created by the relative position creating means,
the common position extracting means performing the extraction of the common positions based on, as the certain relative positions, the relative positions created by the relative position creating means.

7. The authenticating device as set forth in claim 5, comprising:
(I) a relative position storage section for storing the certain relative positions in association with user identification information,
the common position extracting means reading out, from the relative position storage section, the certain relative positions associated with the user to be authenticated, and performing the extraction of the common positions based on the read-out certain relative positions.

8. The authenticating device as set forth in claim 5, further comprising:
(J) relative position creating means for creating part of the relative positions of the sub cards per authentication;
(K) relative position display means for causing the display device to display the relative positions created by the relative position creating means; and
(L) a relative position storage section for storing the rest of the relative positions of the sub cards,
the common position extracting means determining the certain relative positions, based on the relative positions being created by the relative position creating means, and the relative positions being read out from the relative position storage section and associated with the user.

9. The authenticating device as set forth in claim 1, wherein:
if the authentication card has the holes, at least one of the holes is provided with a colored transparent section, or
if the authentication card has transparent sections, at least one of the transparent sections is a colored transparent section,
the authenticating device comprising a color information storage section for storing color position information and color information, the color position information indicating where the colored transparent section is located and the color information indicating the color of the colored transparent section,
the random image creating section performing the creation of the condition meeting random image, based on the color information, the condition meeting random image meeting the condition (a) in terms of a combination of (i) a combination color of the color of a colored unit images appearing through the colored transparent section and the color of the colored transparent section, and (ii) the colors of the colored unit images appearing through the holes or transparent sections not provided with the colored transparent section.

10. The authenticating device as set forth in claim 1, wherein:
the judging means uses a condition (f) instead of the condition (b),
where the condition (f) is such that the color is a color not appearing through plural holes or transparent sections of the authentication card when the authentication card is superimposed on the condition meeting random image.

11. The authenticating device as set forth in claim 1, wherein:
the random image display means includes, in the condition meeting random image, colored unit images of a color identical with a background color of the authentication card at a certain proportion.

12. The authenticating device as set forth in claim 1, wherein:
instead of the colored unit images, the authenticating device uses at least one of:
first unit images which are at least one of characters, pictures, symbols, or numbers;
second unit images which are changed over time and distinctive by an amount of the change over time; and
third unit images which are combinations of at least two of the elements consisting of colored images, characters, pictures, symbols, numbers, and images which are changed over time and distinctive by an amount of the change over time.

13. The authenticating device as set forth in claim 1, wherein:
the authenticating device uses third unit images which are combinations of at least two of the elements consisting of colored images, characters, pictures, symbols, numbers, and images which are changed over time and distinctive by an amount of the change over time; and
the judging means uses a condition (g) instead of the condition (b),
where the condition (g) is such that the obtained answer information indicates part of the elements included in the third unit images appearing through two holes or two transparent section of the authentication card when the authentication card is superimposed on the condition meeting random image.

14. The authenticating device as set forth in claim 2, comprising:
a positional information storage section for storing positional information in association with the user, the positional information indicating where the holes or transparent sections are located on the authentication card,
the random image display means performing the creation of the condition meeting random image, based on positional information associated with the user to be authenticated, and
the judging means performing the judging process, based on positional information associated with the user who requests the authentication.

15. The authenticating device as set forth in claim 2, wherein:
the authentication card including sub cards in which holes or transparent sections are arranged at plural positions in a way specific to the user, the sub cards being changeable in their relative positions by sliding; and
holes or transparent sections common to all the sub cards stacked and positioned respectively at certain relative positions are used as the holes or the transparent sections of the authentication card.

16. The authenticating device as set forth in claim 15, further comprising:
(E) a sub positional information storage section for storing sub positional information in association with the user, the sub positional information indicating where the holes or transparent sections are located on the sub cards; and
(F) common position extracting means for reading out, from the sub positional information storage section, sub positional information associated with a user to be authenticated, and for extracting common positions based on the read-out sub positional information, the common positions being positions where the holes or transparent sections common to all the sub cards are located when the sub cards are stacked and relatively positioned at the certain relative positions,
the random image display means performing the creation of the condition meeting random image, based on the common positions extracted by the common position extracting means, and
the judging means performing the judging process based on the common positions extracted by the common position extracting means.

17. The authenticating device as set forth in claim 16, further comprising:
(G) relative position creating means for creating the relative positions of the sub cards per authentication; and
(H) relative position displaying means for causing the display device to display the relative positions created by the relative position creating means,
the common position extracting means performing the extraction of the common positions based on, as the certain relative positions, the relative positions created by the relative position creating means.

18. The authenticating device as set forth in claim 16, comprising:
(I) a relative position storage section for storing the certain relative positions in association with user identification information,
the common position extracting means reading out, from the relative position storage section, the certain relative positions associated with the user to be authenticated, and performing the extraction of the common positions based on the read-out certain relative positions.

19. The authenticating device as set forth in claim 16, further comprising:
(J) relative position creating means for creating part of the relative positions of the sub cards per authentication;
(K) relative position display means for causing the display device to display the relative positions created by the relative position creating means; and
(L) a relative position storage section for storing the rest of the relative positions of the sub cards,
the common position extracting means determining the certain relative positions, based on the relative positions being created by the relative position creating means, and the relative positions being read out from the relative position storage section and associated with the user.

20. The authenticating device as set forth in claims 2, wherein:
the random image display means includes, in the condition meeting random image, colored unit images of a color identical with a background color of the authentication card at a certain proportion.
